(19) United States
(12) Patent Application Publication
(10) Pub. No.: US 2026/0093213 A1
(43) Pub. Date: Apr. 2, 2026

(54) SYSTEMS AND METHODS FOR AUTONOMOUS INTELLIGENCE

(71) Applicant: XGenesis, Grand Cayman (KY)

(72) Inventors: Todd Darling, Parkland, FL (US); Mehron Massoud Talebi, Parkland, FL (US); Pablo Meles, Weston, FL (US)

(73) Assignee: XGenesis, Grand Cayman (KY)

(21) Appl. No.: 19/411,180

(22) Filed: Dec. 6, 2025

Related U.S. Application Data
(63) Continuation-in-part of application No. 19/372,644, filed on Oct. 29, 2025.
(63) Continuation-in-part of application No. 18/887,187, filed on Sep. 17, 2024.

(51) Int. Cl. G05B 13/02

(52) U.S. Cl. CPC G05B 13/028

(57) ABSTRACT

Systems, methods, and apparatus are disclosed for omnimodal sensing, data fusion, and autonomous decision-making across physical and digital domains and further integrates a Multimodal Diagnostic System (MDS) and Impairment Recognition and Intervention System (IRIS) with defense architecture or a system architecture that can be compliant with the Modular Open Systems Approach (MOSA) and Sensor Open Systems Architecture (SOSA) to ensure interoperability. The system can utilize real-time multisensory fusion, cryptographic provenance via blockchain, and resilient magnetoelectric communication to support mission-critical decision-making across manned and unmanned platforms in denied or contested environments.

### CROSS-REFERENCE TO RELATED APPLICATIONS

This application is a Continuation-in-part of U.S. patent application Ser. No. 19/372,644 filed on Oct. 29, 2025 entitled SYSTEMS AND METHODS FOR OMNIMODAL SENSING, MULTIMODAL DATA FUSION, AND RESILIENT COMMUNICATION FOR DIAGNOSTICS, SAFETY, AND AUTONOMOUS DECISION-MAKING, which is a Continuation-in-part of U.S. patent application Ser. No. 18/887,187 filed on Sep. 17, 2024 entitled IMPAIRMENT RECOGNITION AND INTERVENTION SYSTEM AND METHOD AND APPARATUS and all of the aforementioned applications claim priority thereto and incorporate such applications herein in their entireties.

### FIELD

The present embodiments relate, in general, to methods and systems for sensing, and more particularly, to methods, systems, and devices that use omnimodal sensing, multimodal data fusion, and predictive modeling for intelligent autonomous decision making in various contexts. In some contexts, the embodiments further relate to architectures implementing zero-trust security controls, trusted execution environments, sensor and model provenance verification, and cryptographically authenticated communications, including embodiments operating under strict power, compute, and latency constraints. In certain contexts, the embodiments can be deployed within Modular Open Systems Approach (MOSA) and Sensor Open Systems Architecture (SOSA) aligned platforms and may incorporate a resilient magnetoelectric field-based communication subsystem suitable for subterranean, underwater, and RF-challenged environments

### BACKGROUND

There is growing interest in diagnostics, safety, and autonomous decision making, including, but not limited to, detecting and intervening impaired driving conditions since impaired driving remains a significant public safety concern, contributing to a substantial number of traffic accidents and fatalities worldwide. Traditional methods of detecting impaired driving, such as roadside sobriety tests and breathalyzers, are limited in their scope and application. Other traditional methods of diagnostics, safety, and autonomous decision-making fail to make efficient and logical use of all the data that may be available.

In other contexts autonomous systems, artificial intelligence platforms, and advanced sensor technologies are increasingly deployed in safety-critical, mission-critical, and regulated environments, including not only transportation systems, but industrial automation, medical and surgical robotics, defense platforms, and human-machine interaction. Despite recent progress in machine learning and sensor hardware, the state of the art remains constrained by several fundamental technical deficiencies that limit reliability, safety, interpretability, and robustness across diverse real-world operating conditions.

### Single-Modality Dependency and Lack of Physical Understanding

Conventional autonomous systems rely heavily on one or two sensory modalities—typically visual imagery, LiDAR point clouds, inertial measurements, or basic acoustic signatures—to perceive and interpret the environment. These modalities, while useful for spatial and geometric perception, are inherently limited in their ability to infer physical properties such as mass, friction, deformability, structural integrity, chemical composition, thermal state, airflow characteristics, biological viability, or underlying causal factors associated with hazards or human impairment. Systems dependent on isolated modalities therefore exhibit blind spots, degraded performance in adverse conditions, and an inability to generalize safely to novel scenarios.

### High-Dimensional Predictive Computation and Inefficiency

Modern predictive models frequently operate in raw pixel space, waveform space, or other high-dimensional input domains. Predicting future video frames, acoustic waveforms, or dense sensor maps requires computational resources orders of magnitude beyond what is feasible for real-time, on-device inference—especially in platforms subject to strict thermal, power, or size constraints. As a result, many state-of-the-art predictive systems are cloud-dependent, exhibit unacceptable latency, or fail entirely when network access is intermittent, degraded, or unavailable.

### Absence of Causal Reasoning and Counterfactual Simulation

Existing AI systems largely rely on passive statistical correlation derived from pre-collected datasets. Such systems lack an explicit causal model of how multimodal sensory signals relate to physical phenomena, human behavior, environmental conditions, or unsafe states. Without causal structure, these systems cannot reliably determine “why” an event is occurring, predict how the environment will evolve under alternate conditions, or evaluate hypothetical intervention strategies (“what-if” scenarios). This deficiency contributes to brittleness, poor generalization, and an inability to anticipate hazardous outcomes before they manifest.

### Vulnerability to Spoofing, Tampering, and Adversarial Manipulation

Most contemporary sensor-processing and inference pipelines implicitly assume that input data, model parameters, and system components are trustworthy. In safety-critical or adversarial environments, this assumption is invalid. Sensor spoofing, data injection attacks, electromagnetic interference, tampering with model weights, unauthorized firmware modification, and other malicious actions can cause erroneous or unsafe system behavior. Prior art systems fail to implement continuous, cryptographically verifiable validation of sensor authenticity, model integrity, inference provenance, or actuator authorization.

### Lack of Zero-Trust Security Architecture for AI-based Autonomy

While zero-trust principles have been applied to enterprise networks and identity systems, existing autonomous platforms do not apply zero-trust security to the full sensory, inference, and control loop. There remains an unmet need for architectures that validate every sensor input, every data transformation, every model execution, and every control output before allowing downstream decision-making—particularly through hardware-based Trusted Execution Environments, cryptographic attestations, and immutable provenance records.

### Limited Interoperability and Absence of Open-Architecture Compliance

Many existing AI and autonomy systems are monolithic, vendor-specific, and not aligned with open-architecture standards such as the Modular Open Systems Approach (MOSA) or the Sensor Open Systems Architecture (SOSA). This hinders integration with defense, industrial, aerospace, and transportation platforms that increasingly require modular, interoperable, and future-proof designs. Heritage systems also lack interfaces capable of supporting emerging communication modalities, including resilient low-bandwidth or magnetoelectric field-based links suitable for subterranean, underwater, or RF-challenged environments.

### Inability to Operate Reliably in Denied, Degraded, or Edge-compute Environments

Real-world deployments often require operation in GPS-denied, RF-contested, subterranean, underwater, thermally constrained, or otherwise challenging conditions. Existing AI systems are commonly dependent on cloud connectivity, high-bandwidth communication channels, or large compute clusters. These constraints make them unsuitable for scenarios where connectivity cannot be assumed or where continuous onboard autonomy is required.

### Absence of Unified Safety Supervision and Human-machine Interaction Intelligence

Many robotic, vehicular, and industrial systems lack an integrated safety-supervision framework capable of predicting hazardous trajectories, human intent, physiological impairment, gait abnormalities, chemical exposures, or multimodal indicators of risk. Prior art systems generally react to hazards after they occur rather than predicting and preventing them

### SUMMARY

In some embodiments, a safety-critical autonomous intelligence system can include a processor and a memory storing instructions that, when executed by the processor, cause the processor to perform certain operations. In some embodiments, the operations can include acquiring multimodal sensor data from a plurality of heterogeneous sensors comprising at least two of: visual sensors, acoustic sensors, tactile sensors, thermal sensors, chemical sensors, physiological sensors, inertial sensors, environmental sensors, or magnetoelectric sensors; preprocessing the multimodal sensor data, including at least one of: noise filtering, temporal alignment, sensor-source authentication, integrity verification, modality-specific calibration, or cross-modal consistency checking; generating a unified latent-space representation using a plurality of modality-specific encoders and a joint-embedding fusion module; generating a predicted latent state using a latent-space predictive intelligence model configured to compute at least one of: a time-indexed predicted latent state, a multi-step trajectory forecast, a hazard-forecast metric, or an uncertainty estimate; performing causal reasoning using a causal-learning engine configured to infer causal relationships, generate a causal graph, perform interventional simulations, perform counterfactual simulations, or evaluate alternative hypothetical actions; determining, via a safety-supervisor module, whether an actuator command is permitted, modified, or inhibited based at least in part on: the predicted latent state, a causal-reasoning output, a safety envelope, or an uncertainty metric; and generating a verified actuator command for controlling a mechanical, vehicular, robotic, industrial, medical, wearable, or other physical system only when the actuator command satisfies the zero-trust and safety-supervisor constraints.

In some embodiments, the multimodal sensor data further includes physiological signals derived from thermal-respiratory imaging.

In some embodiments, the chemical sensor includes a volatile organic compound sensor configured to detect analytes associated with impairment, health conditions, or environmental hazards.

In some embodiments, the inertial sensor or gait sensor is configured to capture stride length, cadence, center-of-mass motion, limb-movement asymmetry, or micro-movement instabilities.

In some embodiments, the joint-embedding fusion module is configured to generate uncertainty estimates associated with latent-state predictions.

In some embodiments, the latent-space predictive intelligence model comprises a temporal transformer or recurrent neural network configured to generate multi-step predicted latent-state trajectories.

In some embodiments, the causal-learning engine is further configured to compute causal-attribution scores indicating relative influence of latent variables on predicted outcomes.

In some embodiments, the processor is further configured to perform the operation of enforcing a zero-trust security architecture by verifying at least one of: sensor authenticity, model-parameter integrity, output provenance, or authorization of a control action and wherein enforcing the zero-trust security architecture includes verifying model-parameter integrity using cryptographic signatures or secure-enclave attestation.

In some embodiments, the system further includes a provenance ledger configured to store cryptographic integrity values associated with sensor data, latent-state representations, predictive outputs, or actuator decisions.

In some embodiments, the processor is further configured to operate in a denied, degraded, intermittent, or limited communication (DDIL) environment.

In some embodiments, executing the latent-space predictive intelligence model includes performing inference on an edge-optimized processor subject to thermal, latency, or power constraints.

In some embodiments, a causal-reasoning and counterfactual-simulation system for autonomous intelligence can include a processor and a memory storing instructions that, when executed by the processor, cause the processor to perform certain operations. In some embodiments, the operations include receiving a latent-state representation derived from multimodal sensor data; generating a causal model comprising one or more causal relationships among latent variables; generating a causal graph representing directional dependencies among the latent variables; performing an interventional simulation by modifying at least one latent variable to generate an alternative hypothetical latent state; performing counterfactual reasoning by computing one or more counterfactual outcomes corresponding to the alternative hypothetical latent state; computing a causal impact measure representing a predicted difference between: a baseline predicted latent trajectory and the counterfactual outcome; and providing the causal impact measure to a safety-supervisor module configured to authorize, modify, or inhibit an actuator command.

In some embodiments, generating the causal model includes learning causal structure using structural causal-model techniques.

In some embodiments, performing interventional simulations includes modifying one or more predicted input conditions to generate hypothetical latent trajectories.

In some embodiments, counterfactual reasoning includes evaluating outcomes associated with a changed actuator command or changed environment variable.

In some embodiments, a safety-supervision and control-arbitration system can include a processor and a memory storing instructions that, when executed by the processor, cause the processor to perform certain operations. The operations can include receiving predictive intelligence outputs comprising at least one of: a predicted latent state, a predicted multi-step trajectory, a hazard-forecast metric, or an uncertainty estimate; receiving causal-reasoning outputs comprising at least one of: a causal graph, a causal-attribution score, a counterfactual outcome, or an interventional simulation result; generating a dynamic safety envelope defining permissible operational limits; receiving a candidate actuator command from an autonomous controller, a human operator, or a distributed autonomous node; comparing the candidate actuator command to the dynamic safety envelope; performing control arbitration to permit, modify, inhibit, or override the candidate actuator command; and outputting a verified actuator command to a mechanical, vehicular, robotic, industrial, medical, wearable, environmental, subterranean, or underwater platform only when the verified actuator command satisfies both the dynamic safety envelope and zero-trust constraints.

In some embodiments, generating the dynamic safety envelope includes integrating hazard-forecast metrics with uncertainty estimates.

In some embodiments, the processor is further configured to perform the operation of enforcing one or more zero-trust verification operations on the candidate actuator command, the operations including at least one of: integrity verification, authorization verification, provenance verification, or tamper detection; and where enforcing one or more zero-trust verification operations further includes validating actuator-command provenance and detecting unauthorized or tampered commands.

In some embodiments, performing control arbitration includes initiating a safe-mode or fallback operation when the candidate actuator command exceeds a permissible risk threshold.

In some embodiments, the verified actuator command controls a mechanical, vehicular, robotic, industrial, medical, wearable, environmental, subterranean, or underwater platform.

Accordingly, there exists a clear need for a unified multimodal sensing and predictive intelligence architecture that does one or more of: integrates heterogeneous sensory modalities including chemical, tactile, and physiological inputs; operates in a compact latent space for real-time prediction and simulation; infers causal relationships and supports counterfactual reasoning; implements Zero Trust security throughout the entire autonomous inference pipeline; authenticates all sensors, models, and outputs via hardware-roots of trust; maintains verifiable provenance through cryptographically secured records; complies with MOSA/SOSA open-architecture standards; functions reliably in edge, denied, or degraded environments; and supports safe, interpretable, and proactive decision-making across diverse platforms.

The present invention addresses these and other deficiencies of the prior art.

Glossary:
Actuator Model: Representation of dynamics and limits of actuators.
Adaptive Thresholding: Dynamic decision-threshold adjustment based on context.
Aleatoric Uncertainty: Uncertainty from inherent data noise.
Anomaly Detection Engine: Module detecting deviations from expected behavior.
Atomic Safety Rule: Indivisible safety constraint evaluated in real time.
Attention Mechanism: Neural method highlighting important input features.
Autoencoder: Neural network compressing and reconstructing data.
Bayesian Estimator: Probabilistic state-estimation algorithm.
Blockchain Ledger: Tamper-resistant cryptographic record of events.
Causal Envelope: Boundary of expected causal transitions.
Causal Graph: Directed graph depicting cause-effect relations.
Causal Inference: Deriving cause-effect relationships from data.
Causal State Vector: Latent vector encoding causal structure.
Chemical Sensor: Sensor detecting airborne molecules or VOCs.
CMOSS: C5ISR/EW Modular Open Suite of Standards.
Context Awareness: Understanding environmental and situational context.
Continual Learning Framework: System enabling incremental learning without forgetting.
Control Policy: Logic converting predictions into system actions.
Counterfactual Simulation: Evaluation of hypothetical alternate scenarios.
Critical-Path Safety Kernel: Minimal-latency subsystem for essential safety.
Cross-Modal Correlation: Interdependencies among sensory modalities.
DDIL Environment: Denied, degraded, intermittent, or limited communications.
DDS: Data Distribution Service real-time pub-sub.
Deep Fusion Network: Deep model merging multimodal sensor data.
Digital Twin: Virtual replica of system/environment.
Edge Execution: Running computation on-device at the edge.
Edge Node: Local compute node performing inference.
Electro-Optical Sensor: Sensor capturing light-based signals.
Embodied Intelligence: AI grounded in physical-world interaction.
Environmental Sensor: Sensor capturing atmospheric or ambient data.
Event Camera: Camera capturing changes rather than frames.
Event-Driven Pipeline: Pipeline triggered by events, not fixed cycles.
Fallback Autonomy: Reduced-capability autonomy in degraded modes.
Feature Embedding: Vector representation of features.
Few-Shot Learning: Generalizing from few examples.
Forward Hazard Model: Model predicting future hazards.
Gait Signature: Movement pattern unique to an operator.
Generative Decoder: Model reconstructing data from latent states.
Generative Model: Model producing new samples from learned distribution.
Graph Neural Network: Neural model operating on graph data.
Hash Chain: Cryptographically linked hash sequence.
Hazard Envelope: Model of hazard expansion or containment.
Heterogeneous Sensor Suite: Set of diverse sensors across modalities.
Human State Model: Representation of physiological and behavioral operator state.
Identity Binding: Associating sensor data to authenticated device.
Impairment Signature: Pattern indicating operator impairment.
Joint Embedding Space: Unified latent space for fused data.
Kalman Filter: State-estimation algorithm with Gaussian assumptions.
Knowledge Consolidation: Retention of learned information across updates.
Latent Dynamics Model: Model predicting latent future states.
Latent Space: Compressed representation of complex data.
Lidar Sensor: Laser-based ranging device.
Load Balancer: Distributor of compute across components.
Magnetoelectric Communication: Quasi-static low-frequency communication via ME coupling.
Magnetoelectric Sensor: Sensor detecting ME field variations.
Manipulation Graph: Graph describing feasible physical interactions.
Memory Map: Low-level map linking variables to memory.
Mesh Network: Network where nodes route data collaboratively.
Meta-Learning: Learning to adapt rapidly to new tasks.
Micro-Expression: Small facial signals revealing internal states.
Model Gating: Authorization layer controlling model updates.
Modular Hardware Backplane: Interchangeable hardware module framework.
MOSA: Modular Open Systems Approach.
Multimodal Encoder: Encoder ingesting multiple sensor types.
Multimodal Fusion: Integration of multimodal sensor data.
Multisensory Latent State: Unified representation of fused sensor data.
Neural ODE: Neural ordinary differential equation model.
Object Detection: Identifying entities in sensor input.
Object Tracking: Tracking entity movement over time.
Olfactory Sensor: Sensor detecting odors.
Open VPX: Modular embedded hardware architecture.
Optical Communication: Light-based communication method.
OTA Update: Over-the-air firmware/model update.
Pattern Recognition: Identifying patterns in data.
Perception Stack: Modules for detection, segmentation, tracking.
Physiological Marker: Biological signals indicating operator state.
PID Controller: Proportional-integral-derivative controller.
PKI: Public Key Infrastructure.
Policy Enforcement Point: ZTA mechanism enforcing policy rules.
Predictive Maintenance Model: Model forecasting equipment failure.
Predictive Rollout: Stepped future-state simulation.
Predictive Uncertainty: Confidence estimation in predictions.
Privacy-Preserving Protocol: Protocol protecting sensitive information.
Provenance Ledger: Tamper-resistant record of model/system history.
Reconstruction Error: Difference between input and model reconstruction.
Reinforcement Learning: Learning via reward-based signals.
Representation Drift Detection: Detection of latent distribution drift.
Resource Arbiter: Allocator of compute/memory resources.
RF Communication: Radio frequency-based transmission.
Robust Estimation: Techniques producing stable estimates.
Safety Delta Encoding: Representation of divergence from safety bounds.
Safety Envelope: Boundary of allowable safe operation.
Safety Supervisor: Module arbitrating decisions for safety.
Scene Understanding: Semantic understanding of environment.
Secure Boot: Authenticated firmware startup.
Secure Enclave: Hardware-isolated compute region.
Secure Update Pipeline: Authenticated update mechanism.
Self-Supervised Learning: Learning patterns without labeled data.
Sensor Authentication: Verifying sensor legitimacy.
Sensor Drift Detection: Identifying gradual sensor error.
Sensor Fusion Graph: Graph of fused sensor relationships.
Sensor Open Systems Architecture: SOSA open standard for modular sensors.
Separation Kernel: Security kernel enforcing strict isolation.
Sonar Sensor: Acoustic ranging system.
SOSA: Sensor Open Systems Architecture.
State-Transition Model: Model predicting state evolution.
Structural Causal Model: Formal causal modeling framework.
Swarm Communication: Peer-to-peer multi-agent communication.
Swarm Reasoning: Collective intelligence among agents.
Task Scheduler: Manager assigning workload tasks.
Teacher-Student Distillation: Knowledge transfer from large to small model.
Temporal Alignment Layer: Synchronizer of sensor streams.
Temporal Transformer: Transformer for time-series.
Thermal Sensor: Infrared heat sensor.
Thermal Signature: Heat emission pattern.
Time-Sensitive Networking: Deterministic Ethernet standard.
Trajectory Predictor: Model forecasting movement trajectories.
Trusted Execution Environment: Secure isolated execution region.
Uncertainty-Aware Control: Control incorporating prediction confidence.
Underwater Acoustic Communication: Acoustic signaling underwater.
V2X Communication: Vehicle-to-everything communication.
Version Control Record: Tracking of versioned changes.
Virtual Sensor: Inferred measurement not directly sensed.
Visual Sensor: Camera capturing image data.
VOC Sensor: Volatile organic compound detector.
World Model: Predictive model of environment/agent dynamics.
Zero Trust Architecture: Continuous-verification security model.

### BRIEF DESCRIPTION OF THE DRAWINGS

The accompanying drawings, which are incorporated herein and form part of the present disclosure, illustrate exemplary embodiments of the invention and, together with the detailed description, serve to explain the principles, structure, and operation of the disclosed systems and methods. The drawings are provided for illustrative purposes only and do not limit the scope of the embodiments.

FIG. 1 is a high-level block diagram of a multimodal sensing architecture, illustrating heterogeneous sensory modalities—including visual, acoustic, tactile, olfactory, gustatory, gait or kinetic, and optionally other sensors such as thermal, environmental, and physiological sensors—and in certain embodiments, a joint-embedding encoder configured to fuse these modalities into a unified latent-state representation in accordance with the embodiments;

FIG. 2 is a schematic diagram of a joint encoder fusion module in accordance with the embodiments;

FIG. 3 is a schematic diagram of a latent-space predictive engine (future-state projection and counterfactual simulator) in accordance with the embodiments;

FIG. 4 is a schematic diagram of a counterfactual intervention engine with safety-guided action constraints in accordance with the embodiments;

FIG. 5 is a schematic diagram of a Zero Trust Enforcement Layer and Ledger-Based Provenance Engine in accordance with the embodiments;

FIG. 6 is a schematic diagram of Gait & Physiological State Fusion Module in accordance with the embodiments;

FIG. 7 is a schematic diagram of an Industrial/Surgical Robot Actuation Safety Loop in accordance with the embodiments;

FIG. 8 is a schematic diagram of a Counterfactual Prediction and Outcome Divergence Engine (COPODE) in accordance with the embodiments;

FIG. 9 is a schematic diagram of a Zero-Trust Multimodal Verification Chain (ZT-MVC) in accordance with the embodiments;

FIG. 10 is a schematic diagram of a Modular Open Systems Approach (MOSA) and Sensor Open Systems Architecture (SOSA) and Open Mission Systems (OMS) compliant processing module in accordance with the embodiments;

FIG. 11A is a schematic diagram of a Multimodal Joint Encoder Architecture for Unified Latent Representation in accordance with the embodiments;

FIG. 11B is a schematic diagram of a human-robot shared safety envelope in accordance with the embodiments;

FIG. 11C is a schematic diagram of a resilient low-EM/subsurface/RF-denied communications layer in accordance with the embodiments;

FIG. 11D is a schematic diagram of a degraded-environment autonomous communications state machine in accordance with the embodiments;

Modular Open Systems Approach (MOSA) and Sensor Open Systems Architecture (SOSA) compliant processing module, showing standardized hardware interfaces, data-transport layers, and software-abstraction layers that support integration with defense, industrial, vehicular, medical, and autonomous systems.

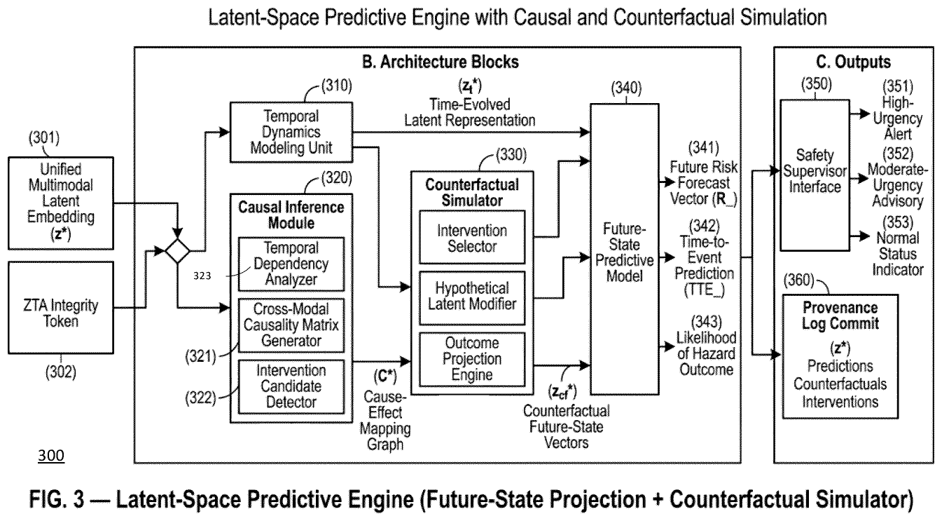

FIG. 3 is a block diagram of a Zero Trust Architecture (ZTA) enforcement layer, illustrating a Trusted Execution Environment (TEE), hardware-rooted attestation mechanisms, a Policy Enforcement Point (PEP), anomaly-detection components, and a distributed-ledger provenance engine configured to verify the authenticity and integrity of all sensor inputs, model operations, and inference outputs.

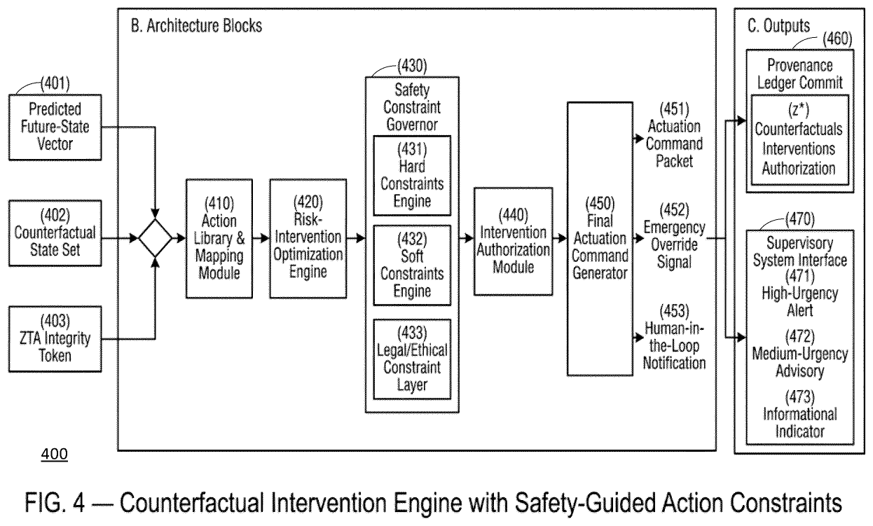

FIG. 4 is a functional sequence diagram depicting latent-space predictive modeling, including multimodal temporal fusion, future-state estimation, hazard progression forecasting, uncertainty quantification, and counterfactual (“what-if”) simulation.

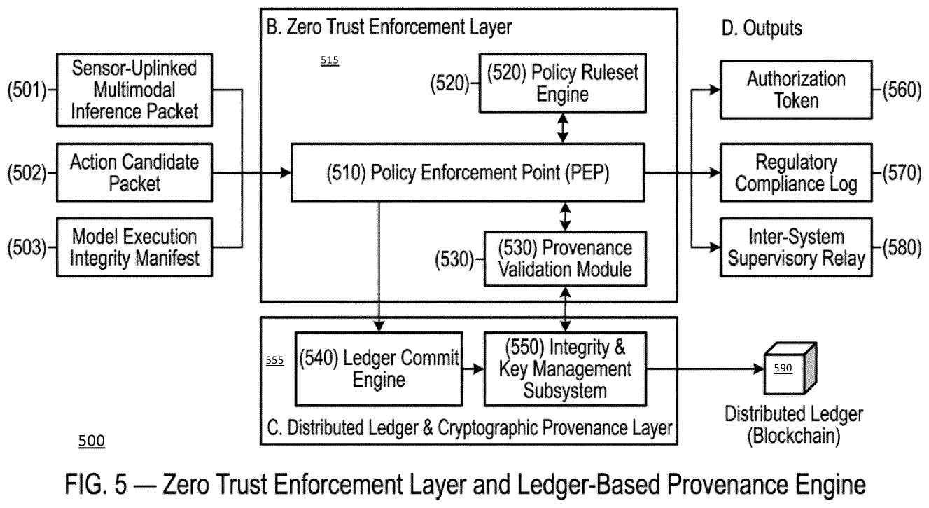

FIG. 5 is an illustration of a robotic manipulation embodiment, showing integration of tactile, visual, acoustic, and chemical sensing within an articulated robotic system and highlighting the flow of multimodal features into a latent predictive model for estimation of object mass, friction, deformability, structural integrity, and associated hazard conditions.

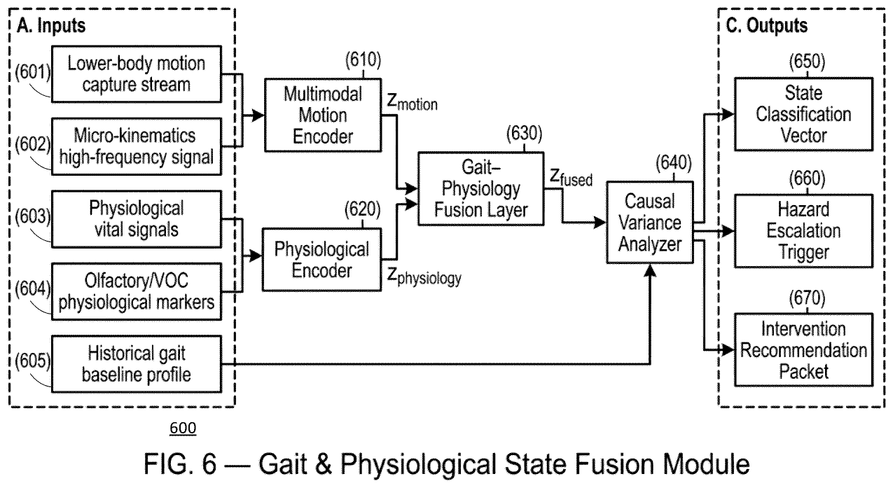

FIG. 6 is a schematic diagram of a surgical robotics embodiment, illustrating multimodal tissue-state sensing—including visual imaging, force detection, acoustic signatures, thermal gradients, and chemical analysis—and predictive modeling for tissue response, risk assessment, and safe trajectory planning.

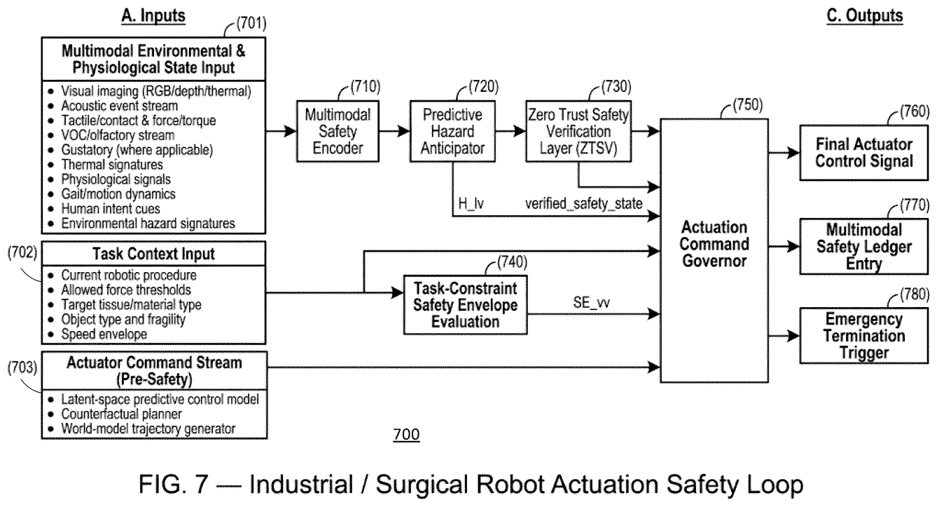

FIG. 7 is a block diagram of a human robot interaction safety system, depicting multimodal monitoring of human pose, gesture, gait, behavior, physiological state, and intent, and showing how predicted future trajectories influence safety-supervisor overrides and control-arbitration decisions.

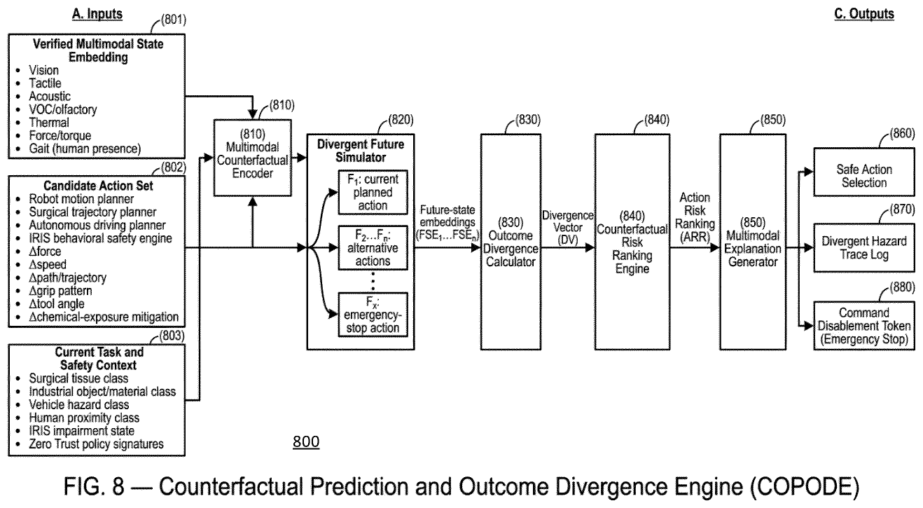

FIG. 8 is a diagram of an autonomous-vehicle embodiment, illustrating fusion of visual, acoustic, mechanical, tactile, thermal, environmental, and chemical sensor inputs to detect emergent hazards, equipment anomalies, roadway conditions, and chemical signatures indicative of fires, leaks, or volatile compounds.

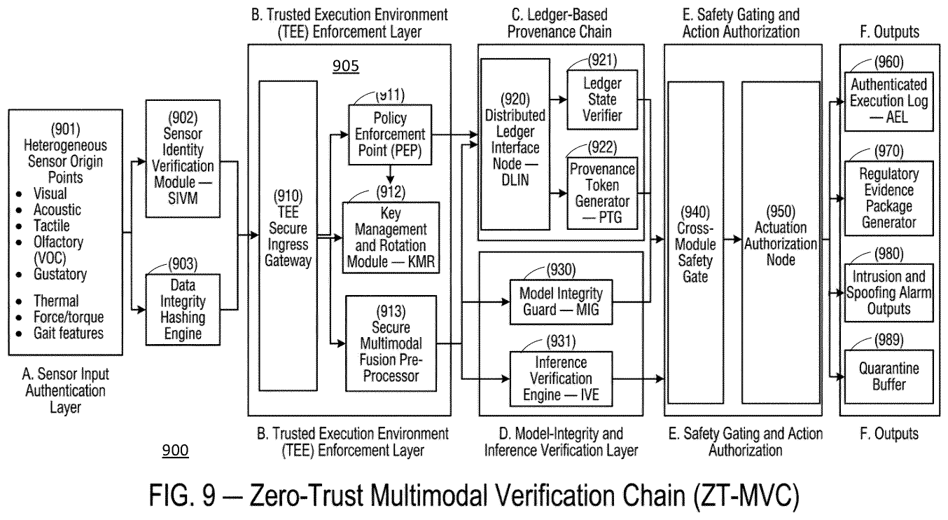

FIG. 9 is an illustration of an industrial automation embodiment, showing multimodal sensing for quality control, defect detection, microcrack identification, material fatigue detection, and latent-space anomaly inference in manufacturing or warehouse environments.

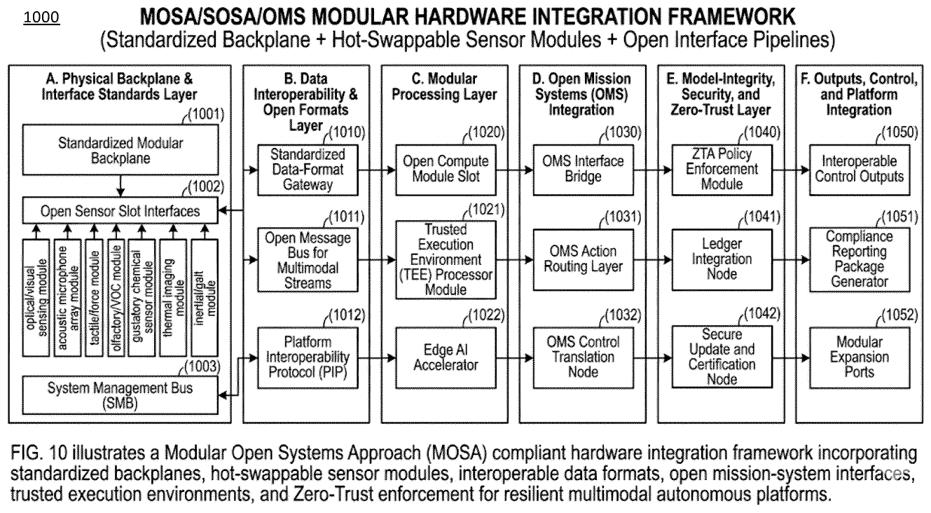

FIG. 10 is a schematic diagram of an edge-optimized deployment architecture, showing quantized inference pipelines, reduced-precision computational modules, neural accelerators, fallback-local-autonomy modes, and mechanisms for real-time multimodal processing under strict power and thermal constraints.

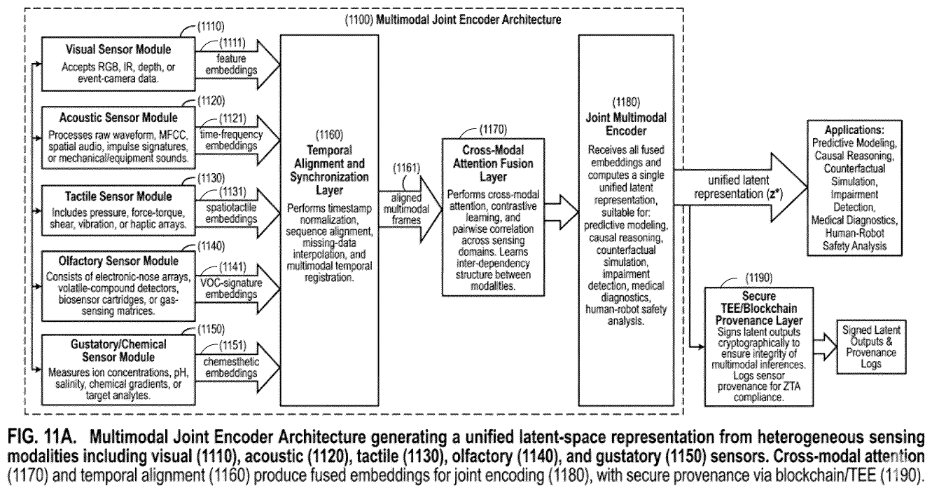

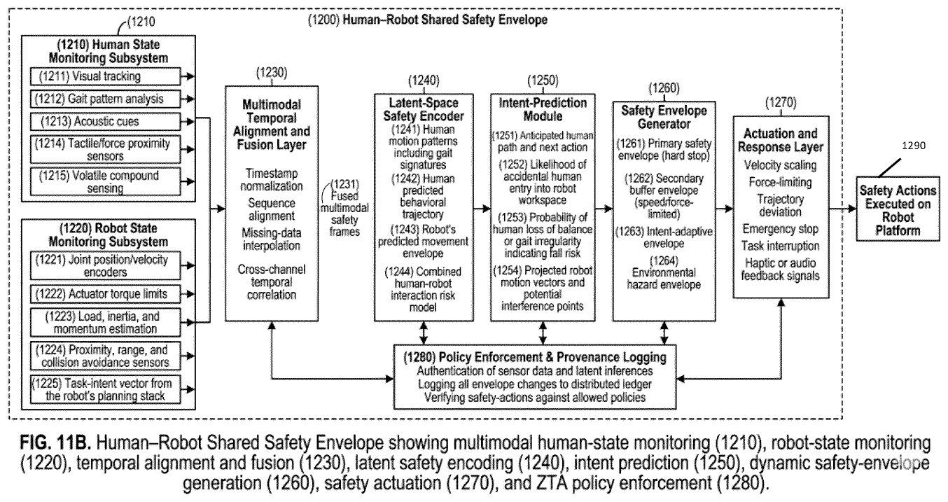

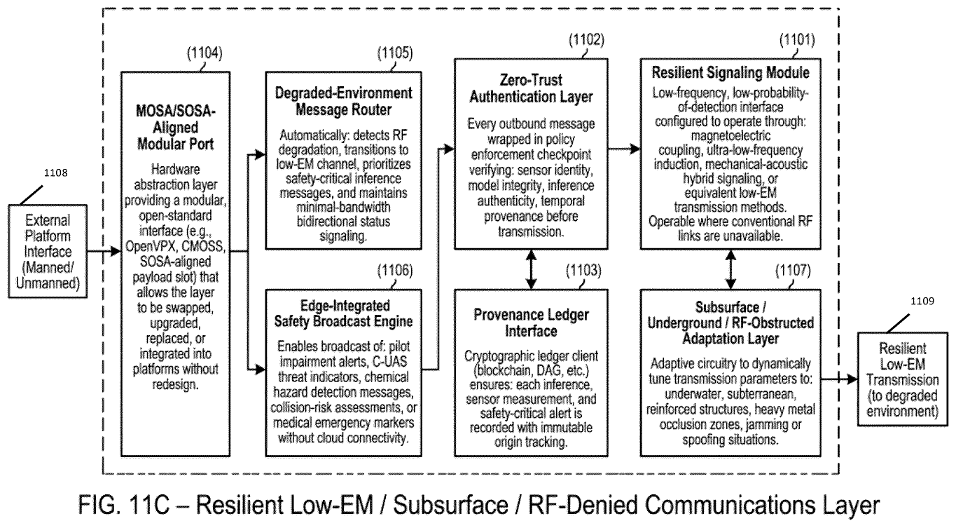

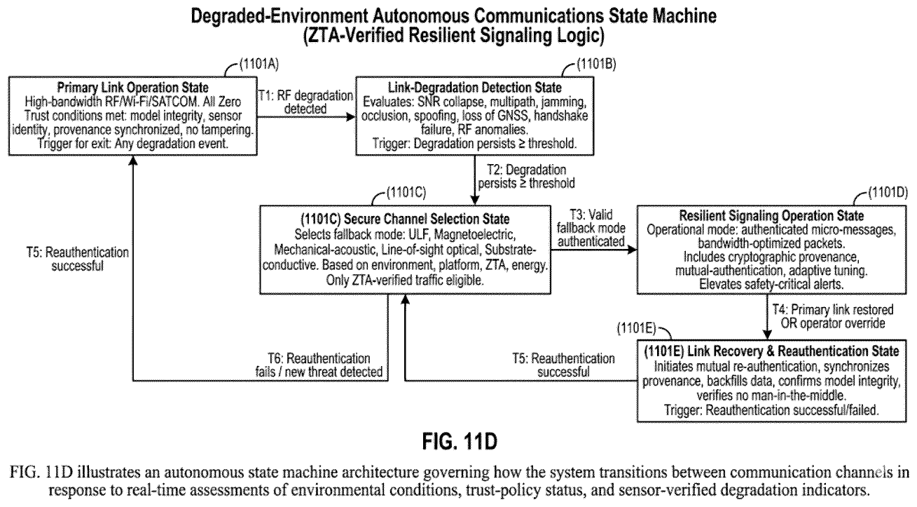

FIG. 11 is a communication diagram illustrating a resilient magnetoelectric field-based communication subsystem and other optional low-frequency communication modalities configured for authenticated transmission of critical safety data in subterranean, underwater, RF-challenged, or GPS-denied environments.

FIG. 12 is a flowchart illustrating causal-learning operations, including latent-space causal-graph construction, dependency inference, causal attribution, and intervention-based updates derived from multimodal temporal and spatial correlations.

FIG. 13 is a sequence diagram showing integration of the ZTA enforcement layer with MOSA/SOSA-aligned hardware, demonstrating verification of sensor authenticity, model integrity, inference provenance, and authorization of control actions.

FIG. 14 is a block diagram of a safety-supervision and control-arbitration framework, illustrating mechanisms for monitoring predicted hazards, enforcing safety thresholds, inhibiting unsafe actions, and resolving command conflicts across autonomous, semi-autonomous, and human-in-the-loop modes.

### DETAILED DESCRIPTION

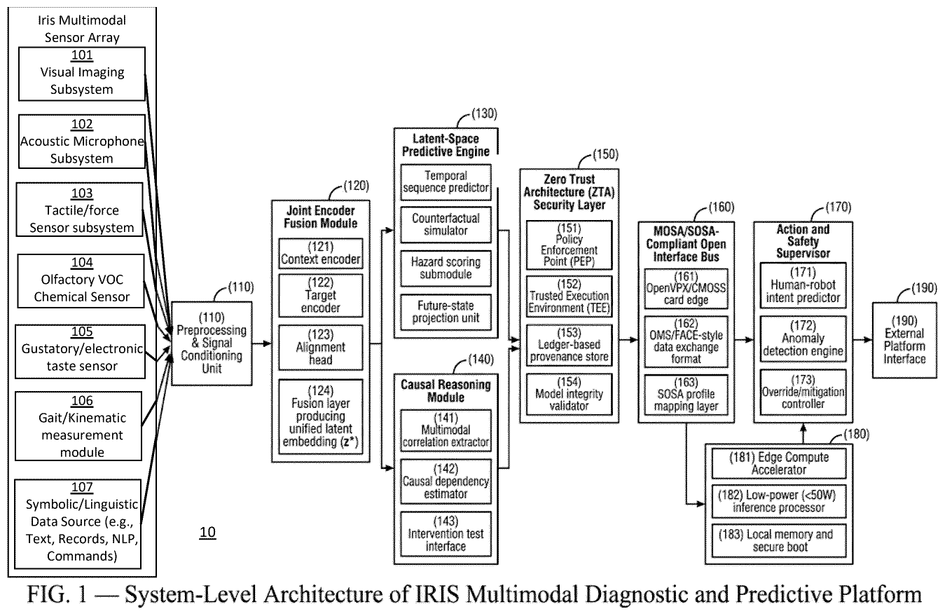

The following detailed description sets forth exemplary embodiments of the present invention. These embodiments are provided to enable a person of ordinary skill in the art to make and use the invention and are not intended to limit the scope of the claims. Unless expressly stated otherwise, the elements and features described herein may be combined, rearranged, substituted, or omitted without departing from the spirit or scope of the embodiments as claimed. All embodiments are non-limiting examples. For clarity, the description is organized into logical subsystems consistent with FIGS. 1-11D.

System Overview. In various embodiments, the present embodiments provide a multimodal sensing, latent-space predictive intelligence, causal reasoning, counterfactual simulation, and zero-trust autonomy system configured for operation across safety-critical, mission-critical, and resource-constrained environments.

As shown in FIG. 1, the system 10 may include:
1. A Multimodal Sensor Acquisition Layer 100. The layer 100 can include sensors, sensor subsystems or modules 101, 102, 103, 104, 105, 106, and 107 as further detailed below.
2. A Preprocessing & Synchronization Layer 110
3. A Joint-Embedding Encoder 120 that can include a context encoder 121, a target encoder 122, an alignment head 123, and a fusion layer producing unified latent embedding 124.
4. A Latent-Space Predictive Intelligence Module 130 that can include a temporal sequence predictor, a counterfactual simulator, a hazard scoring submodule, and a future-state projection unit.
5. A Causal Learning & Counterfactual Reasoning Engine 140 that can include a multimodal correlation extractor 141, a casual dependency estimator 142, and an intervention test interface 143.
6. A Zero Trust Architecture (ZTA) Enforcement Layer 150 that can include a policy enforcement point (PEP) 151, a trusted execution environment (TEE) 152, a ledger-based provenance store 153, and a model integrity validator 154.
7. A MOSA/SOSA-Aligned Processing Module 160 that can include a Open VPX/CMOSS card edge 161, a OMS/FACE-style data exchange format 162, and a SOSA profile mapping layer 163.
8. A Safety Supervisor & Control Arbitration Module 170 that can include a human-robot intent predictor 171, an anomaly detection engine 172, and a override/mitigation controller 173.
9. An Edge-Optimized Deployment Architecture 180 that can include an edge compute accelerator 181, a low power inference processor 182, and a local memory and secure boot 183.
10. An external platform interface 190 which can include an optional Magnetoelectric Field-Based Communication Subsystem.

The architecture generates unified latent-state representations from heterogeneous sensors, predicts future conditions, verifies data integrity, enforces safety constraints, and supports autonomous or semi-autonomous decision-making in real time.

The Multimodal Sensor Array 100 or Acquisition Layer can capture raw sensory inputs from a plurality of heterogeneous sensor modalities designed to supply orthogonal, complementary information about the environment, biological targets, human operators, materials, and system components. The term “sensor modality” is used broadly and encompasses any hardware or software configured to measure, detect, infer, or estimate environmental, physical, chemical, biological, or physiological properties.

Some of the exemplary modalities in various embodiments of the Multimodal Sensor arrary 100 may include two or any three or more of visual imaging sensors 101, acoustic sensors 102, tactile or force sensors 103, olfactory or VOC chemical sensors 104, gustatory or electronic taste sensors 105, gait/kinematic sensors or measurement modules 106 and/or a symbolic/linguistic data source 107 that might include texts, records, NLP or natural language processing information, commands, and/or optical character recognition or OCR data or information. In some embodiments this can be an OCR device or a symbol sensor or a linguistic sensor or any combination thereof.

The visual imaging sensors 101 can include, for example, RGB cameras, Infrared (IR) cameras, Thermal imagers, Depth sensors, Event-based neuromorphic cameras, or Stereo cameras. Visual inputs may capture geometry, luminance, thermal radiation, motion, and structural information.

The acoustic sensors 102 can include, for example, Directional microphones, Microphone arrays, Ultrasonic transducers, Vibration sensors, and/or Hydrophones (for submerged environments). Acoustic signatures can provide material-resonance cues, slip precursors, mechanical failure indicators, and environmental context.

The Tactile and Force Sensors 103 can include, for example, Force/torque sensors, Capacitive touch arrays, Piezoelectric pressure grids, Shear and friction sensors, and/or Electronic “skin” sensors. Tactile information may reveal hardness, deformability, surface texture, slippage, and human contact.

The Olfactory/Chemical Sensors 104 can include, for example, Metal-oxide semiconductor (MOS) gas sensors, Photoionization detectors, Electrochemical gas analyzers, Volatile organic compound (VOC) detectors, and/or Breath or aerosol chemical analyzers. Chemical signatures provide insight into fires, fuel leaks, biological states, environmental hazards, and impairment biomarkers.

The Gustatory/Liquid-Phase/Biosensing Sensors 105 can include, for example, Microfluidic lab-on-chip analyzers, Ion-selective electrodes, Biosensors (optical, electrochemical, enzymatic), and/or Microchannel spectrometers. These may detect pH shifts, ionic composition, biological markers, contaminants, infection indicators, or metabolic byproducts.

The gait or kinematic measurement module or sensor 106 can measure gait features such as stride length, cadence, asymmetry, center-of-mass shift. In some embodiments the sensor 106 may include other sensors such as environmental sensors and physiological sensors. In some embodiments, these additional sensors may be part of a separate module or modules.

Physiological and behavioral signals are critical for impairment detection, triage, and human-intent prediction. The environmental sensors can include sensors of measuring, for example, Humidity, Airflow, Barometric pressure, Vibration, Radiation, Temperature, and/or Electrochemical analytes. The Environmental context enhances robustness and reduces false positives.

The physiological sensor might include sensors for measuring or detecting Thermal patterns, Micro-expressions, Heart rate or respiratory rate inferred from imaging, Movement variability. Physiological and behavioral signals are critical for impairment detection, triage, and human-intent prediction.

The Preprocessing & Signal Conditioning Unit or Synchronization Layer 110 can receive multimodal sensor outputs are transmitted to the Preprocessing & Synchronization Layer 110, where the unit 110 can be configured to Normalize raw signals, De-noise inputs, Perform spectral transforms, Compress or downsample high-rate modalities, Time-stamp and align asynchronous modalities, Reject corrupt or low-confidence sensor packets, and/or Perform sensor integrity checks prior to fusion. This layer ensures temporal and spatial coherence across modalities-a critical requirement for causal learning and latent-space prediction.

The Joint-Embedding Encoder 120 transforms raw multimodal inputs into a unified latent-state representation zₜ that captures essential features across modalities while reducing dimensionality. The encoder 120 can include a context encoder 121, a target encoder 122, an alignment head 123, and a fusion layer 124 producing unified latent embedding that can feed the Latent-space predictive engine 130 and the Casual Reasoning module 140.

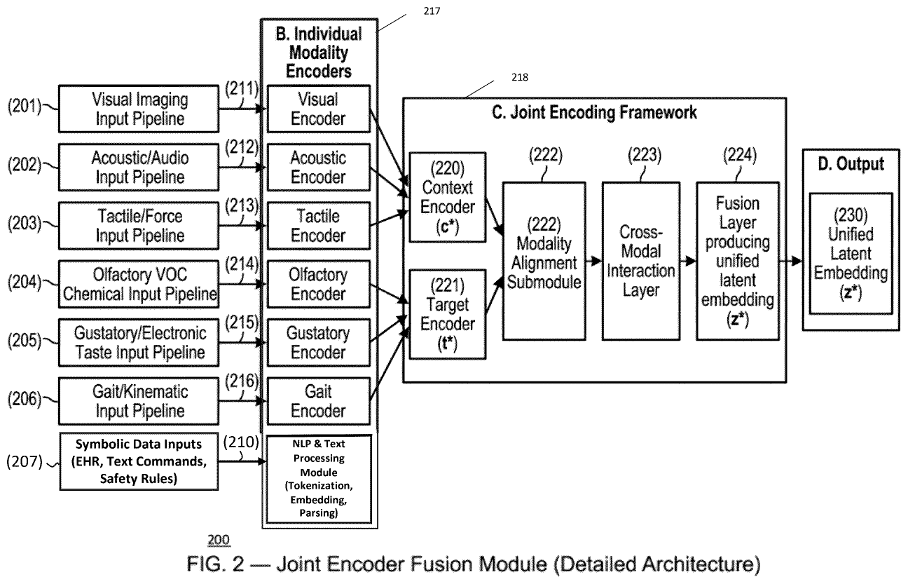

The encoder 120 or 200 as further detailed in FIG. 2 may be implemented using one or more among Convolutional neural networks, Recurrent networks, Temporal convolutional networks, Transformer models, Cross-modal attention layers, Graph neural networks, and Hybrid or hierarchical architectures. The encoder can also include modality-specific sub-encoders where each sensor class may be processed through a dedicated sub-encoder. For example, a Visual sub-encoder can provide spatial-temporal convolution or transformer backbone; an Acoustic sub-encoder can be a spectrogram encoder, MFCC, TCN, or RNN; a Tactile sub-encoder can be a force-vector grid encoder; a Chemical sub-encoder can be spectral feature extractor; a Gustatory sub-encoder can be a microfluidic biosensing encoder; a Physiological encoder can be a temporal-behavioral encoder (including gait), and a NLP & text processing module can be a module that performs one or more various functions including OCR, tokenization, embedding, and/or parsing. Such module can analyze text and speech to grasp meaning, context, and intent, going beyond mere keywords and can further process unstructured data to make sense of vast amounts of text from emails, social media, reviews, and documents, turning it into actionable insights. The module could also extract information and identify entities (people, places), relationships, and sentiment (positive, negative, neutral) in text. In some embodiments, the module can further generate language or create human-like text for responses, summaries, or translations. As noted further below, some embodiments can have any one modality or combination of one or more single-modalities along with NLP coverage and would otherwise cover any contemplated single modality (or combination of single modalities) along with natural language programming.

The joint encoder fusion module 120 can provide cross-modal fusion where outputs may be fused via Learned attention mechanisms, Weighted concatenation, Gated multimodal units, and/or Latent cross-attention transformer blocks. The resulting representation zₜ can have the following properties: Encodes material properties, preserves causal signals, Filters sensor noise, and provides a unified basis for prediction and simulation.

More particularly, the joint encoder fusion module 200 can include the sensors 201, 202, 203, 204, 205, and 206 can provide respectively input pipeline signals 211, 212, 213, 214, 215, 216, and 210 for visual imaging, acoustic/audio, tactile/force, chemical, gustatory/electronic taste, gait/kinematic, and symbolic data inputs to corresponding individual modality encoders 217. The encoders 217 provide inputs to a joint encoding framework 218 that includes context encoders 220 and target encoder 221 that feed a modality alignment submodule 222, a cross-modal interaction layer 223, and a fusion layer producing unified latent embedding 224. The output 230 is the unified latent embedding.

The Latent-Space Predictive Intelligence Module 130 as shown in FIG. 1 can include a temporal sequence predictor, a counterfactual simulator, a hazard scoring submodule and a future-state projection unit.

As further detailed in FIG. 3, a latent-space predictive engine 300 or a latent-space predictive engine with causal and counterfactual simulation in accordance with the embodiments can include a temporal dynamics modeling unit 310 and a causal inference module 320 that receives inputs that include the unified multimodal latent embedding 301 and the ZTZ integrity token 302. The architecture blocks of the engine 300 can further include a counterfactual simulator 330, a future-state predictive model 340 and output modules including a safety supervisor interface 350 and a provenance log commit 360. The causal inference module 320 can include a temporal dependency analyzer 323, a cross-modal causality matrix generator 321, and an intervention candidate detector 322. The counterfactual simulator 330 can include an intervention selector, a hypothetical latent modifier, and an outcome projection engine. The temporal dynamics modeling unit 310 can provide a time-evolved latent representation to the future-state predictive module 340 and the causal inference module 320 can provide a cause-effect mapping graph to the counterfactual simulator 330. The Counterfactual simulator 330 can also provide counterfactual future-state vectors to the predictive module 340. The predictive module 340 can then provide outputs including a future risk forecast vector (R) 341, a time-to-event prediction (TTE) 342, and a likelihood of hazard outcome (343) where can be used by the safety supervisor interface 350 and provenance log commit 360. The safety supervisor interface 350 can provide outputs among a high-urgency alert 351, a moderate urgency advisory 352, and a normal status indicator 353.

Note that the embodiment of FIG. 3 performs predictions in a compressed latent space which can provide a great improvement in efficiency such as a 10X improvement. Further note that the Causal Inference Module (320) and Counterfactual Simulator (330) are distinct, yet integrated components latent-space predictive engine 300. Finally note that the ZTA Integrity Token (302) gates the entire process and how outputs are committed to a Provenance Log (360).

The Latent-Space Predictive Intelligence Module 130 or 300 are configured to perform real-time estimation of future environmental, biological, mechanical, and operational states using the unified latent representation zₜ generated by the Joint-Embedding Encoder 120. Unlike prior art systems that predict in high-dimensional pixel or waveform space, the present embodiments can perform all predictive, generative, and forecasting operations in a compressed latent domain, providing substantial improvements in computational efficiency, robustness, and interpretability.

In various embodiments, the module includes one or more learned latent-dynamics models, temporal sequence models, causal-graph structures, or hybrid predictive architectures that process sequences of latent states {Zₜ} to infer future latent states zₜ₊₁, hazard trajectories, failure modes, physiological changes, or environmental transitions.

In certain embodiments, the predictive module may include Latent Dynamics and State-Transition Modeling such as State-space models, Temporal convolutional networks, Recurrent neural networks (RNN, LSTM, GRU), Transformer-based temporal models, Neural ordinary differential equation (Neural ODE) models, Autoregressive latent-dynamics networks, and Hybrid architectures combining the above. The predictive module receives inputs such as Latent state zₜ, Optional control or action vector aₜ, Optional environmental or contextual metadata and provides outputs such as Predicted latent state \hat{2}ₜ₊₁, Predicted hazard scores, Predicted system-state variables, and/or Uncertainty metrics. In certain embodiments, the system supports multi-step rollouts, enabling prediction over horizons ranging from milliseconds to minutes, depending on application context.

Operating in latent space provides significant advantages in predictive efficiency and computational advantages over pixel-space generative models, including but not limited to at least a ten-fold (10×) reduction in computational load, Reduced memory footprint, Lower latency suitable for edge environments, improved robustness to sensor dropouts, Enhanced resistance to adversarial perturbations, and ability to perform thousands of predictive rollouts per second. This efficiency renders the embodiments viable in mobile, embedded, and thermally constrained hardware environments where legacy world-model architectures fail.

The predictive module (130) may detect or forecast Hazard Progression and Failure-Mode Forecasting such as Mechanical degradation, Material fatigue or failure, Thermal runaway, Chemical reaction onset, Human impairment trajectories, Physiological state deterioration, Surgical tissue risk progression, Object slippage or collision likelihood, Roadway hazard emergence, and/or Microcrack propagation in industrial systems. These predictions are generally generated prior to the occurrence of observable failure signals in raw sensor space, providing a unique anticipatory capability not available in vision-only or single-modality systems.

In some embodiments, the predictive module 130 can use uncertainty quantification and may compute one or more among Bayesian uncertainty estimates, Aleatoric/epistemic uncertainty decomposition, Confidence bounds, Predictive variance, and risk-weighted hazard scores. These ensure safe operation in ambiguous or partially observable environments.

Some embodiments can include a counterfactual intervention engine 400 with safety-guided constraints as illustrated in FIG. 4. The engine 400 can utilize inputs of a predicted future-state vector 401, counterfactual state set 402 and a ZTA integrity token 403 to provide outputs that include a provenance ledger commit 460 and a supervisory system interface 470. The provenance ledger commit 460 can provide counterfactual interventions and authorizations while the supervisory system interface 470 can provide a high-urgency alert 471, a medium urgency alert 472, and/or informational indicator 473. The inputs are fed to an action library and mapping module 410, a risk intervention optimization engine 420 and a safety constraint governor 430. The governor 430 can include a hard constraints engine 431, a soft constraints engine 432, and a legal/ethical constraint layer 433 as shown. The governor 430 can provide signaling to an intervention authorization module 440 that further feeds a final actuation command generator 450 which provides either an actuation command packet 451, an emergency override signal 452, or a human-in-the-loop notification 453 to the outputs 460 and 470.

FIG. 4 illustrates the transition from prediction (FIG. 3) to autonomous action. It visually represents the “Counterfactual Intervention Engine,” showing how the system translates latent predictions into safe, constrained, and cryptographically verified real-world interventions which is useful for autonomous safety. FIG. 4 further illustrates from prediction to action by mapping latent-space predictions and counterfactuals directly to a predefined Action Library (410), without expensive pixel-space reconstruction. The system 400 of FIG. 4 further demonstrates Safety & Compliance Gating using the Safety Constraint Governor (430) and Intervention Authorization Module (440), demonstrating how the system enforces hard rules (FDA, FAA, DoD) and soft constraints before any action is taken. The system 400 also illustrates Zero Trust Enforcement by showing the ZTA Integrity Token (403) as an input and the final decision being committed to a Provenance Ledger (460) which is useful for mission-critical autonomy. The system 400 also includes inputs as clear entry points for the Predicted Future-State Vector (401), Counterfactual State Set (402), and ZTA Integrity Token (403), core processing with a central processing flow from the Action Library (410) to the Risk-Intervention Optimization Engine (420), then through the critical Safety Constraint Governor (430), and finally to the Intervention Authorization Module (440) and Final Actuation Command Generator (450). The system 400 further includes distinct output paths for the Provenance Ledger Commit (460) and the Supervisory System Interface (470).

The latent-space predictive module 130 integrates with the Counterfactual Reasoning Engine (What-If″ Engine) 140 to evaluate hypothetical outcomes by modifying, Latent variables, Action vectors, Environmental conditions, Physiological parameters, and Mechanical constraints. The examples can include Predicting the outcome of increasing robotic grip force; Assessing whether a vehicle trajectory change eliminates a collision risk; Determining whether altered gait or posture reduces fall probability; Simulating surgical tool adjustments to reduce tissue damage; Testing alternative industrial machine settings to avoid breakage; Exploring different responses to chemical or VOC changes.

This counterfactual capability is a novel and non-obvious feature that enables optimal intervention selection, robust prevention strategies, and enhanced compliance with safety standards.

Predictive Causality (along with Temporal Reasoning) may be established by Latent-space dependency graphs, Temporal causal attention, Structural causal models, Perturbation-based causal attribution, Dynamics-based causal validation. This ensures that predictions reflect causal, not merely correlative, relationships, providing transparency and explainability for regulatory reporting.

Some of the embodiments can have integration with ZTA and provenance. All predictions generated by the latent-space module can be Executed within a TEE (152), cryptographically signed, logged to a distributed provenance ledger (153), and Validated against safety (154) and authorization policies using a policy enforcement point (151) as shown in FIG. 1. This ensures tamper-evident prediction, trusted execution, Secure human-machine interaction, and forensic accountability.

In one embodiment as shown in FIG. 5, a zero trust enforcement layer and ledger-based provenance engine 500 includes sensor-uplinked multimodal inference packet(s) 501, action candidate packet(s) 502, and model execution integrity manifest 503 as inputs to a zero trust enforcement layer 515 that includes a policy enforcement point (PEP) 510, a policy ruleset engine 520, a provenance validation module 530. The PEP 530 feeds a ledger commit engine 540 and the provenance validation module feeds an integrity & key management subsystem that makes up part of a distributed ledger and cryptographic provenance layer 555. The zero trust enforcement layer 515 and more particularly the PEP 510 provides an authorization token 560, a regulatory compliance log 570, and an inter-system supervisory relay 580 as outputs. The Distributed Ledger & cryptographic provenance layer 555 and more particularly the subsystem 550 provides an output to the distributed ledger 590 on a blockchain.

The engine 500 of FIG. 5 moves the technology from “just AI” to “secure, auditable, and compliant AI.” The system 500 introduces the PEP 510 as a gatekeeper for AI actions, not just network access. The Distributed Ledger (540), Provenance Validation (530), and Key Management (550) blocks, it provides the technical blocks that can be used for security. The system 500 also has regulatory & liability Value by providing a Regulatory Compliance Log (570) and Ledger Commit Engine (540) demonstrating immediate utility for liability mitigation and compliance.

Referring to FIG. 6, a gait & physiological state fusion module 600 can include inputs including one or more of lower-body motion capture stream 601, micro-kinematics high-frequency signal 602, physiological vital signals 603, olfactory/VOC physiological markers 604, and/or historical gait baseline profile 605. Inputs 601 and 602 can flow through a multimodal motion encoder 610 and inputs 603 and 604 can flow through a physiological encoder 620. The output Zmotion from the encoder 610 and the output Zphysiology from the encoder 620 can be fed to a gait-physiology fusion layer 630 which provides a fused output (Zfused) to a casual variance analyzer 640. The output from the historical gait baseline profile 605 is also fed to the casual variance analyzer 640. The casual variance analyzer can provide the outputs of a state classification vector 650, a hazard escalation trigger 660, and/or an intervention recommendation packet 670.

FIG. 7 illustrates an Industrial/Surgical Robot Actuation Safety Loop 700. More particularly, FIG. 7 illustrates an embodiment of a predictive, multimodal, Zero-Trust-verified actuation safety architecture for robotic systems operating in surgical, industrial, or other safety-critical environments. The system fuses heterogeneous sensory inputs, evaluates task-specific safety envelopes, anticipates hazards through latent-space predictive modeling, and governs downstream actuation commands to ensure safe operation.

The loop or system 700 can include several inputs including Multimodal Environmental & Physiological State Input(s) 701 which can include signals from a broad set of heterogeneous sensor modalities, including, but not limited to: Visual imaging (RGB, depth, infrared, thermal), Acoustic event streams, Tactile/contact and force torque sensing, VOC/olfactory chemical signatures, Gustatory/chemical-contact sensing (where equipped), Thermal and heat-flux signatures, Physiological measurements (e.g., perfusion, hemodynamics, biosignals), Gait and whole-body motion dynamics (e.g., joint trajectories, footfall patterns, instability cues), Human intent cues (pose estimation, micro-gestures, EMG/biopotentials), and/or Environmental hazard indicators (smoke, fumes, temperature spikes, mechanical failures). This full sensorium forms the raw embodied state for real-time multimodal safety inference.

The inputs to loop 700 can further include Task Context Input(s) 702 which can provide operational constraints and task-specific safety parameters, including, for example: Current robotic procedure or task phase, Permitted force thresholds, Target tissue or material type, Object fragility and allowable deformation, Speed envelope and permissible tool velocities, Safety-critical procedural transitions (e.g., incision→cauterization→suturing).

The inputs to loop 700 can further include Actuator Command Stream (Pre-Safety) 703 which can carry the robot's pre-safety actuation intentions, including, but not limited to: Latent-space predictive control trajectories, Counterfactual motion proposals, World-model-derived trajectory generators, Learned or optimized motion primitives, Operator-issued guidance or high-level intents. These streams represent the system's proposed actions prior to safety evaluation.

The loop 700 further incudes a core safety pipeline including a Multimodal Safety Encoder 710 that transforms raw sensory inputs (701) into a unified latent-state safety representation, preserving: Cross-modal correlation, Temporal alignment, Uncertainty estimation, Causal cues (force→deformation→hazard progression). This latent representation feeds forward into hazard anticipation and safety verification stages.

A Predictive Hazard Anticipator 720 consumes the encoded latent state and performs: Future-state prediction, Counterfactual “what-if” simulation, Hazard progression modeling, Pre-impact collision/strain estimation, andBehavioral drift detection (including gait or pose instability in humans nearby). The anticipator 720 also outputs a hazard likelihood vector (H_lv). A Zero Trust Safety Verification Layer (ZTSV) 730 ensures that all safety-related outputs are trustworthy. It performs: Cryptographic attestation of sensor integrity, Model-component validation inside a TEE, Provenance logging via distributed ledger, Spoofing/tampering detection, Safety-state confirmation before actuation. The layer 730 generates a verified_safety_state that acts as a hard gate for downstream control.

A Task-Constraint Safety Envelope Evaluation 740 merges task context (702) with predicted hazards to determine: Whether the proposed actuation lies within the safe procedural envelope; Material-specific and anatomy-specific safety limits; Speed/force compliance; Forbidden-zone intrusion detection; Real-time constraint violation alerts. Its output is a safety-envelope validity vector (SE_VV).

The Outputs for the loop 700 include an Actuation Command Governor 750 that fuses Pre-safety actuation commands (703), Predicted hazards (H_lv), Verified safety state (from ZTSV), and Task-constraint envelope outputs (SE_vv). The governor 750 may Approve the actuation, Modify parameters (force, speed, trajectory), Substitute a safer motion primitive, or Abort the action entirely. This module (750) is the final arbiter before physical movement via a Final Actuator Control Signal 760 in the form of a safe, adjusted actuator command to the robot's motors, instrumentation, or manipulators. The governor can also provide a Multimodal Safety Ledger Entry 770 which can be in the form of cryptographically authenticated log of: Sensor state; Safety evaluations; Actuation decisions; Hazard predictions. This enables regulatory compliance, auditing, forensic reconstruction, and operator accountability. The governor 750 can also provide an Emergency Termination Trigger 780. For high-risk scenarios, the system 700 and trigger 780 performs: Instant actuation freeze, Power gating, Tool retraction, and/or Operator alert signaling. This can be triggered when hazards exceed allowable thresholds or Zero Trust verification fails.

The embodiment of FIG. 700 illustrates Multimodal & Predictive Safety showing how diverse inputs like VOC/olfactory (701) and gait signals (701) are fused and used by the Predictive Hazard Anticipator (720) to foresee risks before they happen. The system 700 also integrates a Zero Trust Safety Verification Layer (ZTSV) (730) directly into the actuation loop, a novel approach that ensures the integrity of the safety decision itself. The system 700 also illustrates Task-Aware Governance demonstrating how safety is contextualized by the Task Context Input (702) and enforced by the Actuation Command Governor (750), which can modify or abort commands based on real-time constraints.

FIG. 8, which illustrates the Counterfactual Prediction and Outcome Divergence Engine (COPODE) 800. It visually represents the system's ability to not just predict the future, but to simulate multiple alternative futures (“what-ifs”), compare their risks, and select the safest path. This is different from standard predictive models and is useful for safety-critical autonomy. The system 800 simulates parallel futures as it explicitly shows a Divergent Future Simulator (820) branching out to model multiple alternative actions ($F_1 . . . F_n, F_x$), including emergency stops. The system 800 also quantifies risk by introducing an Outcome Divergence Calculator (830) and Counterfactual Risk Ranking Engine (840), which mathematically computes and ranks the risk of each simulated future. The system 800 can further provide explainability & compliance by including a Multimodal Explanation Generator (850) and Divergent Hazard Trace Log (870), which are essential for regulatory compliance (FDA, FAA, DoD) and liability mitigation.

The system or engine 800 can include clear entry points or inputs for the Verified Multimodal State Embedding (801), Candidate Action Set (802), and Current Task & Safety Context (803) as shown. Core processing for the engine 800 can include a central processing flow where inputs 801 and 803 feed into the Multimodal Counterfactual Encoder (810). This leads to the Divergent Future Simulator (820), which takes input 802 to generate multiple future states. These states are passed to the Outcome Divergence Calculator (830), then to the Counterfactual Risk Ranking Engine (840), and finally to the Multimodal Explanation Generator (850). The generator provides distinct output paths for Safe Action Selection (860), Divergent Hazard Trace Log (870), and Command Disablement Token (Emergency Stop) (880).

The predictive module may be deployed on Hardware-Agnostic and Edge-Optimized Implementations using one or more of Embedded CPUs, GPUs, NPUs/TPUs, FPGAs, ASIC accelerators, and Hybrid heterogeneous compute platforms. The architecture can be designed to operate at under 50 watts, at reduced precision (INT8, FP16), under thermal and size constraints, and without cloud dependency.

As illustrated in various figures, the combination of Causal Learning and Counterfactual Reasoning Engines 130/140 are configured to infer, validate, and utilize directed cause-and-effect relationships embedded within multimodal latent-state representations. Unlike correlational deep-learning systems that infer statistical patterns without understanding underlying physical or physiological mechanisms, the present embodiments explicitly construct causal graphs, identifies intervention-dependent relationships, and enables hypothetical future-outcome simulation through latent-space perturbation and structural modification.

The causal engine 140 operates in close cooperation with the Latent-Space Predictive Intelligence engine 130, enabling anticipatory decision-making, risk-aware intervention selection, and high-confidence safety supervision.

In various embodiments, the causal reasoning engine or module 140 includes one or more mechanisms for constructing causal dependency graphs from temporal sequences of latent states {zₜ}. These mechanisms may include Structural Causal Models (SCMs), Causal Bayesian Networks, Neural causal-discovery networks, Granger-type temporal causality estimators, Directed acyclic graph (DAG) learning algorithms, Attention-weighted causal transformers, and/or Invariant causal prediction (ICP) techniques.

The causal graph may encode directed edges representing, Material property dependencies, Human physiological drivers and outcomes, Chemical source-effect relationships, Mechanical failure precursors, Environmental causal chains, Behavioral cues linked to intent or impairment, and/or Latent-variable interactions that produce emergent hazards. The system may automatically determine which sensory modalities provide causal versus correlative contributions.

The causal engine 140 may perform latent-space attribution, identifying which latent variables that Trigger downstream hazards, affect physiological impairment trajectories, Influence robotic manipulation outcomes, Drive gait abnormalities or human-intent changes, Produce mechanical failures or industrial anomalies, and/or Amplify or mitigate environmental risks.

By working entirely in latent space, the engine Reduces computational burden, Avoids noise in high-dimensional raw data, enhances robustness to sensor dropouts, and Achieves causal interpretability not possible in pixel space.

In certain embodiments, the causal engine 140 supports interventional reasoning, in which latent variables or contextual parameters are deliberately modified to simulate hypothetical scenarios. Examples include Determining whether altering grip force reduces object slippage; Assessing how steering adjustments change a predicted collision outcome; Evaluating how modified tool trajectories influence tissue safety in surgery; Predicting whether gait stabilization prevents a fall event; Testing whether modifying chemical exposure mitigates risk of toxicity; Exploring mechanical-load variations to avoid catastrophic failure; Simulating industrial machine settings to prevent defects or microcracks.

The counterfactual engine (see 130 or 330 in FIG. 3) may compute Counterfactual latent states, Intervention-specific hazard scores, Outcome probabilities under alternative actions, and/or Optimal intervention strategies. These capabilities permit anticipatory intervention, a key differentiator over prior-art reactive systems.

The causal engine may also evaluate Time-Varying and Multi-Step Causal Effects that can include Long-horizon causal influence chains, Compounding effects of sequential actions, Time-varying variable importance, Cascading failure sequences, Recursive causal dependencies. For example: Human physiological markers may degrade before gait patterns destabilize; Mechanical strain may accumulate before thermal runaway; Road-surface chemistry may shift before a traction loss event. The engine models these temporal causal cascades, producing early warnings and enabling preventive interventions.

In some embodiments, the causal engine computes Causal Uncertainty Quantification by determining one or more of Probability distributions over causal edges, Confidence intervals around causal weights, Epistemic uncertainties in inferred causal structure, and Intervention-outcome uncertainty metric. This ensures conservative decision-making in ambiguous conditions and strengthens regulatory trust.

Integration with Zero Trust Architecture (ZTA). Causal inference results are subject to continuous validation by the Zero Trust Architecture (ZTA) 150, including: Integrity verification (154) of causal models via hardware-rooted attestation, Cryptographic signing of causal-graph updates, Provenance logging (153) of intervention simulations, and Authorization checks for causal inferences or downstream control actions. All causal computations occur within a Trusted Execution Environment (TEE) 152, protecting against Model poisoning, Unauthorized modifications, Causal-graph tampering, and/or Spoofed intervention requests.

In some embodiments, as illustrated in a Zero-Trust Multimodal Verification Chain (ZT-MVC) 900 of FIG. 9. The system 900 can be a cornerstone for security and compliance. It visually demonstrates the novel integration of Zero Trust principles directly into the multimodal sensing, processing, and actuation pipeline. Again, this integration differs from systems that apply security only at the network edge or cloud level.

In some embodiments, the system 900 provides End-to-End Zero Trust as it shows the chain of trust from Sensor Origin Points (901) through the Trusted Execution Environment (910), to Model Integrity (930), and finally to Actuation Authorization (950). This proves that every step is verified, and not assumed. The system 900 also includes Ledger-Based Provenance as it integrates a Distributed Ledger Interface (920) and Provenance Token Generator (922), creating an immutable audit trail that is essential for regulatory compliance (DoD, FDA, NHTSA). The system 900 also provides Active Security Gating where active defense mechanisms like the Policy Enforcement Point (PEP) (911), Cross-Module Safety Gate (940), and Quarantine Buffer (989), demonstrate a robust, preemptive security architecture.

The system 900 includes a clear entry point or inputs for the Heterogeneous Sensor Origin Points (901), leading to the Sensor Identity Verification Module (SIVM) (902) and Data Integrity Hashing Engine (903) as shown. The system 900 also includes Core Processing (B, C, D, E) including: A central, detailed processing flow starting with a trusted execution environment enforcement layer 705 having a TEE Secure Ingress Gateway (910). Inside the TEE, data flows to the Policy Enforcement Point (PEP) (911), then to the Secure Multimodal Fusion Pre-Processor (913). In parallel, the Key Management Module (912) interacts with the PEP 911. The output then branches to the Ledger-Based Provenance Chain (920, 921, 922) and the Model-Integrity and Inference Verification Layer (930-931). All validated outputs converge in the Safety Gating and Action Authorization Layer (940 and 950).

Outputs include distinct output paths for the Authenticated Execution Log (960), Regulatory Evidence Package Generator (970), Intrusion and Spoofing Alarm Outputs (980), and the Quarantine Buffer (989).

Safety-Supervisor Integration. The causal engine 140 informs the Safety Supervisor (and Control Arbitration Module) 170 by: Generating risk-weighted causal hazard curves; Predicting unsafe trajectories; Identifying interventions likely to prevent accidents; Evaluating the causal impact of proposed control actions. This enables the Safety Supervisor to: Override unsafe commands; Throttle or inhibit system actions; Enforce safe-human interaction envelopes; and/or Maintain compliance with policy and regulatory constraints.

The causal engine may be applied in a wide variety of contexts, including, but not limited to: Impairment detection (respiratory, thermal, behavioral, gait-based); Surgical robotics and tissue-response modeling; Autonomous-vehicle hazard forecasting; Industrial predictive maintenance; Chemical-hazard progression modeling; Human-intent and behavior prediction; Defense and public-safety DDIL environments. In each domain, causal inference reduces false positives, increases interpretability, and supports real-time safety interventions.

Unexpected Technical Benefits. The integration of multimodal latent-space prediction with causal and counterfactual reasoning yields several non-obvious advantages over prior art, including, but not limited to: Ability to infer hazards before they manifest in raw sensor data; High interpretability suitable for regulated industries; Superior robustness in edge environments; Strong resistance to spoofing, tampering, and adversarial perturbations; Capability to provide real-time “explanations” for autonomous decisions; Continuous adaptation without violating ZTA constraints; and Domain-general applicability across medical, industrial, transportation, and defense sectors.

The Zero Trust Architecture (ZTA) Security (or Enforcement) Layer 150 provides continuous, cryptographically enforced verification of authenticity, integrity, provenance, authorization, and policy compliance across the entire multimodal autonomy pipeline. Unlike classical autonomous or AI systems that implicitly trust sensor inputs, firmware, model parameters, communication channels, or control outputs, the present invention treats every component, data pathway, and computational step as untrusted by default. The ZTA Enforcement Layer applies zero-trust controls to all stages, including: sensor acquisition; preprocessing and synchronization; latent-space encoding; predictive inference; causal reasoning and counterfactual simulation; safety-supervisor arbitration; communication signaling; and/or actuator issuance. The result is a tamper-resistant, spoof-resistant, and policy-verifiable autonomous intelligence framework suitable for safety-critical and mission-critical deployments.

In various embodiments, all critical operations are executed inside a Trusted Execution Environment (TEE) 152, which may include ARM TrustZone; Intel SGX; RISC-V Keystone; FPGA-or ASIC-based secure enclaves; and/or Hardware Security Modules (HSMs). The TEE provides: Hardware-rooted cryptographic isolation; Memory protection; Controlled entry/exit points; Verified execution of model components; Secure key storage; and/or Protected model-update pathways. The TEE 152 ensures that: Model parameters cannot be modified without attestation; Sensor-fusion operations cannot be bypassed; Predictive and causal computations cannot be tampered with; Unsafe firmware cannot be injected; Spoofed control signals are rejected.

The ZTA layer 150 can perform Sensor Authentication and Data Integrity Verification. The ZTA layer 150 validates all multimodal sensor inputs using: Embedded digital signatures; Hardware IDs; Challenge response authentication; Cryptographic nonce-based freshness checks; Timing-consistency analysis; Physics-based plausibility tests; and/or Modality cross-consistency verification. Each arriving sensor packet can be classified as: trusted, degraded-confidence, or untrusted, based on both cryptographic and physical-consistency criteria.

Sensor data with insufficient provenance is either: rejected outright, downweighted, flagged for anomaly analysis, or isolated in a constrained inference pathway.

The ZTA layer 150 further protects internal model integrity by: signing model weights with hardware-rooted keys; hashing sub-model components; performing attestation before inference; storing lineage records on an immutable cryptographic ledger; and/or blocking execution if weight signatures fail verification.

In various embodiments, the provenance system logs: raw sensor authenticity metadata; latent-space transformations; prediction timestamps; causal-graph updates; counterfactual-simulation outputs; safety-supervisor overrides; and/or actuator-command authorization results. The distributed provenance ledger may be maintained locally, on-edge, synchronized opportunistically, or replicated through authenticated communications.

Policy Enforcement Point (PEP) and Authorization Engine. As shown in FIGS. 1 and 5, a Policy Enforcement Point (PEP) 151 or 510 performs real-time authorization checks before allowing any inference, model-update action, or control output to influence system behavior. Policies may include: safety-threshold rules; behavioral constraints; access-control lists; model-update permissions; hazard-response rules; and/or regional or regulatory requirements.

The PEP 151/510 evaluates: the identity of the requesting component; the trust status of the input data; causal hazard predictions; uncertainty quantities; context-dependent safety envelope. Commands that violate policy constraints are blocked, modified, or routed to the Safety Supervisor 170.

The ZTA layer can include anomaly-detection and spoofing countermeasures. The ZTA layer 150 can include anomaly-detection components that compare multimodal consistency across sensors; detect signature mismatches; identify timing anomalies; detect physics-inconsistent behaviors; monitor TEE integrity; cross-reference provenance histories. Detected anomalies may trigger: safe-state transitions; control-surface inhibition; degraded-mode autonomy; resynchronization attempts; provenance-ledger alerts; and/or communication to authenticated operators. This capability is essential in adversarial contexts, regulatory environments, and DDIL operations.

All intra-system and inter-system communications can be authenticated and encrypted. In some embodiments, signaling may be transmitted via: conventional RF channels; wired secure links; optical pathways; resilient magnetoelectric field-based transmission modalities (without naming BlueME); low-frequency subsurface communication links; and/or underwater acoustic or ME signaling channels.

The communication subsystem (see FIG. 11C) provides: integrity assurance; encryption; origin authentication; replay-attack resistance; fallback safety signaling when primary channels fail. This ensures continuity of safety-critical operations even in: subterranean; underwater; RF-contested; GPS-denied; and/or degraded networks.

Integration with Safety Supervisor and Control Arbitration. The ZTA Enforcement Layer validates one or more of: predicted future states; causal-inference outputs; counterfactual simulations; hazard curves; intervention recommendations; operator commands; actuator instructions. Invalid, manipulated, ambiguous, or unprovenanced data is not permitted to affect system behavior. As shown in FIG. 9, the ZTA layer ensures that only authorized, verified, and context-safe actions reach downstream control interfaces.

Zero-Trust for Model Updates and Continual Learning. In some embodiments, the system supports secure continual learning, where gradients, model updates, replay buffers, distilled teacher signals, reinforcement-learning updates are all: verified cryptographically, executed inside the TEE, logged in the provenance ledger, authorized by the PEP, bounded by safety rules. This prevents: model-poisoning attacks, unauthorized bias injection, adversarial retraining, and/or unverified policy changes.

Unexpected Technical Benefits. The integration of ZTA with multimodal, causal, and predictive intelligence yields technical advantages not taught or suggested by prior art, including: end-to-end tamper resistance; cryptographically backed safety verifications; trusted causal reasoning; provenance-verifiable predictions; hardened autonomy under DDIL conditions; unspoofable sensor fusion; litigation-resilient forensic auditability; and/or regulator-trusted explainability.

Safety Supervisor and Control Arbitration Module. As illustrated in FIG. 11B, the Safety Supervisor and Control Arbitration Module 1200 provides a real-time decision-making layer configured to evaluate predicted hazards, multimodal uncertainty estimates, causal-graph outputs, physiological indicators, human-behavioral cues (including gait-derived features), mechanical diagnostics, and contextual environmental data. Based on this evaluation, the Safety Supervisor determines whether system actions are permitted, inhibited, modified, or overridden in accordance with safety rules, regulatory constraints, mission profiles, or operational risk thresholds. Unlike prior-art supervisory systems that rely on single-modality thresholds or manually tuned heuristics, the present embodiments employ multimodal latent-space prediction, causal inference, and counterfactual reasoning to proactively determine the safest action before a hazard materializes.

In various embodiments, the Safety Supervisor 1200 constructs dynamic safety envelopes mathematical and policy-driven boundaries that define safe operational space in latent, spatial, temporal, physiological, or mechanical domains. Safety envelopes may include: Proximity envelopes prohibiting contact or unsafe approach; Physiological envelopes reacting to signs of impairment, fatigue, distress, or respiratory abnormalities; Gait envelopes guarding against instability, fall risk, or erratic locomotion; Thermal envelopes preventing overheating, burns, or thermal runaway; Chemical envelopes triggered by VOCs, combustion precursors, or hazardous analytes; Mechanical envelopes for torque, vibration, pressure, or structural loads; Trajectory envelopes for autonomous vehicle or robotic movement; and/or Causal envelopes representing inferred latent-variable dependencies that predict unsafe outcomes. These envelopes are continuously updated using predicted future states \hat{z}ₜ₊ₖ, where k may represent multi-step forecast horizons.

Hazard Detection and Risk Scoring. The Safety Supervisor 170 or 1200 receives multimodal hazard indicators from Sections 5-6, including: latent-space predictive hazard scores; uncertainty metrics; causal-inference outputs; intervention-simulated risk deltas; ZTA trust levels for each sensor and model component; mechanical/thermal/chemical anomaly indicators; physiological and behavioral (including gait) anomalies; control-surface-level mechanical stress estimates.

In some embodiments, the Safety Supervisor 170 or 1200 computes: risk-weighted danger indices, hazard severity tiers, temporal hazard gradients, and probabilistic risk envelopes. Hazards may include: potential collisions, slips, or falls; emergent fires, leaks, or chemical exposures; surgical tissue risk, hemorrhage likelihood, or tool-trajectory hazards; vehicular trajectory conflicts; industrial machine-failure precursors; human-impairment indicators relevant to IRIS functionality.

Arbitration Between Competing Command Sources. In certain embodiments, the system may include multiple command sources, such as: autonomous control policies; human operator inputs; supervisory mission profiles; regulatory or geofencing constraints; robotic behavior controllers; continuous learning agents operating inside the TEE. The Safety Supervisor serves as a final authority on whether any command is enacted. Arbitration rules may include: Human override rules where Human commands may take precedence unless unsafe or inconsistent with causal hazard predictions; Autonomous-policy override rules wher Autonomous commands that violate safety envelopes are inhibited or modified; Regulatory/geofenced constraints where Actions conflicting with jurisdictional, industrial, or medical-safety regulations are blocked; Causal-prediction-driven overrides where Commands that are predicted to generate unsafe causal cascades are replaced with safer alternatives; Uncertainty-gated arbitration where Commands are down-weighted or rejected if predictive uncertainty exceeds specified thresholds; and/or ZTA authorization rules where Commands lacking full provenance, integrity, or attestation are disallowed entirely.

The Safety Supervisor may modify unsafe commands by: adjusting trajectory curves; reducing speed, torque, or grip force; altering path-planning waypoints; switching to “safe-mode” variants; delaying execution until safety conditions improve; imposing motion damping; modifying tool position, force, or angle in surgical embodiments; rebalancing gait-assist actuators (exoskeleton/robotic); triggering multimodal alerts or haptic feedback. Where modification cannot resolve risk, unsafe commands may be replaced with safe substitute actions, such as: emergency stop; retreat or retraction maneuvers; neutral positioning; minimal-intervention posture; and/or fallback operational modes for DDIL environments.

Safe-State Transitions and Graceful Degradation. In some embodiments, the Safety Supervisor supports degradation profiles such as: fallback to minimal autonomy; sensor-reduction modes when some modalities become untrusted; safe mechanical retraction; emergency shutdown sequences; ME-based authenticated signaling when primary communications fail; and/or ZTA-verified operator handoff. These enable continuity of safety even in: adversarial settings, unstable networks, underwater/subterranean scenarios, RF-challenged domains, severe sensor degradation conditions.

Human-State and Human-Intent Integration. In certain embodiments, the Safety Supervisor incorporates real-time interpretation of: pose; gesture; facial micro-expressions; thermal respiratory signatures; environmental physiological cues; and/or gait-derived human intent attributes such as directional commitment, instability, fatigue, impairment, or agitation. These are fused with causal predictions to infer: whether an operator is impaired; whether a pedestrian will cross unexpectedly; whether a patient is physiologically destabilizing; whether a collaborator is likely to enter a hazardous zone; and/or whether a fall is imminent.

Regulatory and Mission-Profile Compliance. In various embodiments, the Safety Supervisor 170 or 1200 enforces domain-specific regulatory logic, such as: ISO/ASTM robotic safety standards; FDA-related surgical-robotic safety constraints; automotive safety frameworks; OSHA/industrial machine-safety boundaries; defense-sector MOSA/SOSA/CMOSS compliance boundaries; medical physiological-monitoring thresholds; chemical, thermal, radiation, or environmental exposure limits. Compliance is guaranteed via: ZTA-verified decision flowpaths; causal hazard validation; and/or authorized constraining of control signals.

Integration With ZTA Enforcement Layer. Every decision of the Safety Supervisor is: executed within the TEE; cryptographically attested; provenance-logged; cross-checked for causal consistency; validated against all policies; and/or bound by multimodal trust classifications. Unsafe or unverified pathways are automatically rejected.

Unexpected Technical Benefits. The Safety Supervisor delivers significant advantages over prior art, including: proactive risk mitigation using forward prediction, not reactive triggers; human-intent and impairment inference from multimodal cues including gait; robust arbitration across noisy, degraded, or adversarial conditions; cryptographically enforced safety boundaries; universal applicability across medical, industrial, vehicular, robotic, and defense systems; non-spoofable, non-tamperable safety enforcement via ZTA.

Modular Open Systems Approach (MOSA) and Sensor Open Systems Architecture (SOSA) Integration. As illustrated in FIGS. 1 and 10, the embodiments may be deployed within a Modular Open Systems Approach (MOSA) and/or Sensor Open Systems Architecture (SOSA)-compliant hardware and software framework. MOSA and SOSA collectively define open, modular, and interoperable standards for defense, aerospace, transportation, industrial, and autonomous-systems integration. Unlike monolithic prior-art platforms, the present embodiments are expressly configured for one or more of: plug-and-play hardware interchangeability; multi-vendor interoperability; scalable software modularity; lifecycle upgradability; cross-platform sensor integration; secure distributed deployment; continuous improvement of AI components within cryptographically validated boundaries.

In various embodiments, the system may be constructed using Hardware Modularity and Standardized Interfaces such as Open VPX-aligned backplanes; CMOSS or VICTORY-aligned modules; FACE-compliant software components; Ethernet-based data distribution buses; SOSA-aligned payload slots; FPGA or ASIC accelerators on modular carrier cards. Hardware interfaces may support: optical, RF, acoustic, and low-frequency communication channels; PCIe, VPX, MIPI, or custom digital sensor buses; secure hardware-enforced attestation via TEE; thermal-optimized embedded compute clusters. Sensors may be added or removed without requiring system redesign, enabling rapid field reconfiguration.

In certain embodiments, the system includes software abstraction layers, permitting: standardized sensor drivers; modality-agnostic acquisition APIs; cross-platform fusion pipelines; accelerated compute kernels (GPU, NPU, FPGA); containerized model deployments; updateable software-defined policies; real-time safety and arbitration constraints. These abstraction layers ensure that: the multimodal joint-embedding encoder 120 (or see FIG. 11A), the latent-space predictive intelligence module 130, the causal engine 140, the ZTA layer 150, and the Safety Supervisor 170 remain interoperable across diverse hardware configurations.

Data Transport and Message Frameworks. The embodiments can implement: DDS (Data Distribution Service); TSN (Time-Sensitive Networking); MIL-STD-1553 or ARINC-derived channels; encrypted Ethernet messaging; authenticated inter-module signaling; deterministic timing-guaranteed transport. These frameworks ensure: bounded latency; deterministic scheduling; verified message provenance; non-bypassable ZTA enforcement; synchronized multimodal processing.

Sensor Interoperability and Extensibility. The embodiments support seamless integration of new or upgraded sensors, including: additional visual cameras or depth sensors; expanded tactile arrays; chemical or biosensing upgrades; gait-tracking or physiological packages; thermal and airflow sensors; new communication subsystems. Because multimodal fusion occurs in latent space, any new sensor merely requires: a sub-encoder integration; cross-modal calibration; validation within the ZTA pipeline. No monolithic retraining is required.

Secure Plug-and-Play Model Updates. In certain embodiments, the system supports model updates or swaps through: signed update packages; attested neural-network upgrades; modular sub-encoder replacement; secure container deployment inside the TEE; cryptographically verified rollbacks. All updates: are executed only after ZTA authorization; maintain provenance logs; preserve compatibility with MOSA/SOSA constraints.

Interoperability Across Diverse Domains. the MOSA/SOSA design enables deployment in: autonomous vehicles, including ground, air, and maritime; subterranean and underwater systems; industrial robotics and manufacturing platforms; medical robotics and surgical-assist devices; defense and public-safety systems; edge-deployed IoT/operational-tech infrastructure. This domain-agnostic interoperability is a major differentiator over prior-art systems built for singular applications.

Support for Resilient Communication Modalities. In various embodiments, MOSA/SOSA infrastructure accommodates the optional magnetoelectric field-based communication subsystem, enabling: secure authenticated signaling; fallback communications in RF-denied environments; low-bandwidth safety messaging; multimodal synchronization across distributed nodes. This capability is fully modular and compatible with the open-architecture bus and payload-slot model.

Unexpected Technical Benefits. MOSA/SOSA integration yields several non-obvious advantages, including, but not limited to: unified multimodal sensing enriched by domain-composable hardware; improved longevity and upgrade pathways without system replacement; rapid adaptability to emerging standards; increased trust from government and industry integrators; reduced lifecycle cost due to modularity; enhanced security due to ZTA-compliant module boundaries; seamless inclusion of new sensing, communications, or AI components.

Referring again to FIG. 10, it is important to note that a MOSA/SOSA/OMS modular hardware integration framework as illustrated is not a generic computer, but rather defines specific hardware components in combination like a Standardized Modular Backplane (1001), hot-swappable Sensor Slot Interfaces (1002), and dedicated Trusted Execution Environment hardware (1021). It demonstrates that the complex AI described in previous figures requires specialized, integrated hardware architecture to function in real-world scenarios. Also note that the U.S. Department of Defense (DoD) is mandated by federal law (under Title 10 U.S.C.) to use a Modular Open Systems Approach (MOSA) for their major weapon systems. In other words, the various embodiments of IRIS is designed to include AI and further plug immediately into next-generation equipment such as jets, autonomous ground vehicles, and naval platforms without requiring custom, proprietary hardware redesigns

FIG. 10 details the specific methodology of using the architecture of taking multimodal AI (from FIG. 1), passing it through standardized gateways (1010), processing it in modular AI slots (1020), and routing the decisions via OMS bridges (1030). The system is also hardened via the Zero Trust Security Model where systems 500 and 900 of FIGS. 5 and 9 introduced the concept of Zero Trust and Ledger-based provenance logically. FIG. 10 further shows how that security is physically enforced at the “metal level.”

The claimed embodiments demonstrate that security isn't just a software check; it involves physical components like the System Management Bus (1003) detecting module insertion, and a hardware-based TEE Processor Module (1021) handling encryption separate from general computing.

By including Modular Expansion Ports (1052) and defining generic slots for compute and sensors, FIG. 10 ensures viability for not just today's technology, but tomorrow's as well. If a new type of neuromorphic processor or quantum sensor is invented five years from now, it can plug into the IRIS framework described in FIG. 10 without being beyond the claimed contemplated scope.

Referring again to FIG. 10, a framework 1000 can include multiple layers including a physical backplane & interface standards layer, a data interoperability & open formats layer, a modular processing layer, an open mission systems (OMS) integration layer, a model-integrity, security, and zero-trust layer, and an outputs, control and platform integration layer. The layers flow as illustrated and can include various components. The physical backplane & interface standards layer can include a standardized modular backplane 1001 that couples to open sensor slot interfaces 1002. The physical backplane & interface standards layer can also include a system management bus 1003. The data interoperability & open formats layer can include the standardized data-format gateway 1010, an open message bus for multimodal streams 1011, and a platform interoperability protocol module 1012. The modular processing layer can include an open compute module slot 1020, a TEE processor module 1021, and an edge AI accelerator 1022. The OMS integration layer can include an OMS interface bridge 1030, an OMS action routing layer 1031, and an OMS control translation node 1032. The model-integrity, security, and zero-trust layer can include a ZTA policy enforcement module 1040, a ledger integration node 1041, and a secure update and certification node 1042. The outputs, control and platform integration layer can include interoperable control outputs 1050, compliance reporting package generator 1051, and modular expansion ports 1052.

In summary, whereas previous figures defined how IRIS thinks, FIG. 10 defines how IRIS exists and operates in the real world, specifically aligning it with the mandatory standards of its largest potential customers.

Referring to FIG. 11A, a multimodal joint encoder architecture or system 1100 solves the fundamental problem of “sensory overload” in autonomous systems, enabling the advanced reasoning capabilities described elsewhere in the patent.

The system 1100 enables efficiency and can perform causal reasoning and counterfactual simulation (predicting future states). If the AI had to process raw video pixels, raw audio waveforms, and raw chemical signals simultaneously every time it needed to make a prediction, the computational load would be staggering. It would be too slow for real-time surgery or combat. In some embodiments, the system 1100 of FIG. 11A solves this by creating the “Unified Latent Representation ($z$)” (Block 1180).* It compresses massive amounts of noisy, heterogeneous data into a compact, mathematical “shorthand.” This compact vector ($z*$) is what allows the downstream engines (like the Predictive Engine in FIG. 3 and the Counterfactual Simulator in FIG. 8) to run fast enough to be useful. Without the architecture in FIG. 11A, the rest of the embodiments might be theoretically possible but practically unfeasible.

The system 1100 can also overcome a “Temporal Misalignment” problem. In real-world multimodal systems, sensors don't report data at the same speed. A camera might capture frames at 60 Hz, while a chemical sensor might only register a change every few seconds, and an audio sensor is streaming continuously. If you feed this messy timing into an AI, it gets confused about cause and effect. System 110 can explicitly address this issue with the “Temporal Alignment and Synchronization Layer” (Block 1160). By laying claim to the specific mechanism of aligning these diverse streams before encoding them, we tackle a known, difficult engineering challenge in robotics.

In some embodiments, by explicitly architecting a system that handles multiple modalities such as five distinct modalities, including the rarely used Olfactory (1140) and Gustatory/Chemical (1150) sensors, system 1100 stakes out a massive territory of innovation.

The system 1100 also “Bakes-in” Zero Trust Security at the Source and that ZTA isn't just a software firewall added at the end. By including the Secure TEE/Blockchain Provenance Layer (1190) right inside the encoder, the embodiments demonstrate that security begins the moment data is converted into a latent state. It ensures that the fundamental “thoughts” of the AI are cryptographically signed and traceable back to the specific sensors that generated them. This is typically essential for regulatory compliance in medical and military fields.

The Multimodal Joint Encoder Architecture for Unified Latent Representation 1100 can be configured to ingest diverse, heterogeneous sensor streams and generate a single, unified latent-space representation (z*). This architecture corresponds to the “Joint Encoder Module” utilized within the broader IRIS CIP-2 system for high-efficiency predictive modeling and causal reasoning. The architecture (1100) begins on the left side with a plurality of individual, modality-specific processing modules configured to receive raw or pre-processed sensor data and output domain-specific embeddings including a Visual Sensor Module (1110): configured to accept data from sources such as RGB cameras, infrared (IR) sensors, depth sensors (e.g., LiDAR or ToF), or neuromorphic event cameras. It outputs visual feature embeddings (1111), utilizing encoders such as convolutional neural networks (CNNs) or vision transformers; an Acoustic Sensor Module (1120): configured to process inputs like raw audio waveforms, Mel-frequency cepstral coefficients (MFCC), spatial audio arrays, impulse signatures, or mechanical equipment sounds. It outputs time-frequency embeddings (1121); a Tactile Sensor Module (1130): configured to handle data from pressure arrays, force-torque sensors, shear sensors, vibration detectors, or haptic feedback devices. It outputs spatiotactile embeddings (1131) representing physical contact dynamics; an Olfactory Sensor Module (1140): configured to interface with electronic-nose arrays, volatile organic compound (VOC) detectors, biosensor cartridges, or gas-sensing matrices. It outputs VOC-signature embeddings (1141) representing environmental chemical composition; and/or a Gustatory/Chemical Sensor Module (1150): configured to measure fluid properties such as ion concentration, pH levels, salinity, chemical gradients, or specific target analytes. It outputs chemesthetic embeddings (1151).

These distinct embeddings (1111, 1121, 1131, 1141, 1151), which may arrive asynchronously and at different rates, are transmitted to the Temporal Alignment and Synchronization Layer (1160). This layer is configured to perform timestamp normalization, sequence alignment across modalities, interpolation of missing data packets, and multimodal temporal registration, producing a stream of aligned multimodal frames (1161).

The aligned frames (1161) are then processed by the Cross-Modal Attention Fusion Layer (1170). This layer applies mechanisms such as cross-modal attention, contrastive learning, and pairwise correlation analysis to learn the inter-dependency structure between different sensory domains (e.g., associating a specific visual object with its corresponding acoustic signature and tactile hardness).

The output of the fusion layer 1170 is received by the Joint Multimodal Encoder (1180). This encoder computes the final unified latent representation (z), a high-dimensional vector that compresses the essential state information from all input modalities. As depicted, this unified representation (z) is suitable for immediate use in downstream applications including predictive modeling, causal reasoning, counterfactual simulation, impairment detection, medical diagnostics, and human-robot safety analysis.

Parallel to the application output, the unified latent representation (z)* is routed to the Secure TEE/Blockchain Provenance Layer (1190). This layer is configured to cryptographically sign the latent outputs to verify the integrity of the multimodal inference and to log sensor provenance data into a distributed ledger or secure log, ensuring compliance with Zero Trust Architecture (ZTA) protocols. The output is a set of signed latent outputs and provenance logs verifiable by external systems.

In summary, the system 1100 of FIG. 11A details the specific mechanical process by which raw, chaotic world data is transformed into the ordered, secure, and compact fuel required by the advanced AI brains described in the rest of the application herein. It turns an abstract concept of “multimodal fusion” into a concrete architecture.

Referring to FIG. 11B, a human-robot shared safety envelope 1200 illustrates a central nervous system for human-robot safety within the IRIS architecture. While FIG. 10 provides the physical body (hardware integration) and FIG. 11A provides the sensory cortex (the joint latent encoding of diverse signals), FIG. 11B describes the high-level safety logic that governs actual physical interaction. It is the bridge between abstract AI reasoning and concrete, life-critical physical actions. The envelope 1200 solves the “frozen robot” problem in shared workspaces and provides deep integration of gait analysis for safety.

A major limitation in current collaborative robotics is that safety systems are too conservative. They rely on simple geometric “bubbles” around a human. If a human enters the bubble, the robot freezes. This destroys productivity. FIG. 11B solves this through “Intent Prediction” (Block 1250). By moving beyond simple distance measurement and instead using multimodal data (gait, gaze, acoustic cues) to predict where the human is going and what they are about to do, IRIS can create a dynamic, adaptive safety envelope (Block 1260). The robot doesn't just stop; it slows down, changes its path, or limits its force output, allowing work to continue safely. This is a massive commercial differentiator for industrial, home, and medical robotics. The system 1200 also deeply integrates gait analysis for safety. Gait analysis is often treated as a standalone biometric. FIG. 11B integrates gait directly into the safety loop.

By including Gait Pattern Analysis (1212) and using it to determine the Probability of Human Loss of Balance (1253), the system can anticipate falls or erratic movements before they happen. A robot can preemptively back away from an unstable human or determine to help stabilize the human and prevent a fall based on probability of success or a positive outcome and moving from passive safety to include active intervention. This is a highly novel safety feature with immense value in healthcare (elder care robotics) as a robot that can gently provide a stabilizing force to prevent a hip fracture is a revolutionary medical device. This is also important in industrial settings where workers might be fatigued or carrying heavy loads stumbles, a robot that backs away might still let the load fall on them. A collaborative robot (“cobot”) that recognizes the stumble via gait analysis and applies supportive counter-force to the load could prevent a crushing injury.

Referring again to FIG. 11B, the human-robot shared safety envelope 1200 includes a human state monitoring subsystem 1210 (including one or more among visual tracking 1211, gait pattern analysis 1212, acoustic cues 1213, tactile/force proximity sensors 1214, and/or volatile compound sensing 1215) and a robot state monitoring subsystem 1220 (including one or more among joint position/velocity encoders 1221, actuator torque limits 1222, load, inertia, and momentum estimation 1223, proximity, range, and collision avoidance sensors 1224, and/or task-intent vector from the robot's planning stack 1225. The inputs from subsystems 1210 and 1220 are fed to the multimodal temporal alignment and fusion layer 1230 that can include timestamp normalization, sequence alignment, missing-data interpolation, and cross-channel temporal correlation. The layer 1230 provides fused multimodal safety frames 1231 to a latent-space safety encoder 1240 which further flows progressively through an intention-prediction module 1250, a safety envelope generator 1260 and actuation and response layer 1270 before providing safety actions 1290 executed on a robot platform. A policy enforcement and provenance logging layer 1280 further interfaces with each of elements 1230, 1240, 1250, 1260, and 1270 where the layer 1280 performs authentication of sensor data and latent inferences, logs all envelope changes to a distributed ledger, and verifies safety-action against allowed policies.

In some embodiments, the latent-space safety encoder 1240 can include human motion patterns including gait signatures 1241, human predicted behavioral trajectory 1242, robot's predicted movement envelope 1243, and a combined human-robot interaction risk model 1244. In some embodiments, the intent-prediction module 1250 can include anticipated human path and next action 1251, a likelihood of accidental human entry into robot workspace 1252, a probability of human loss of balance or gait irregularity indicating a fall risk 1253, and projected robot motion vectors and potential interference points 1254. In some embodiments, the safety envelope generator 1260 includes a primary safety envelope (hard stop) 1261, a secondary buffer envelope (speed/force-limited) 1262, a intent-adaptive envelope 1263, and an environmental hazard envelope 1264. In some embodiments, the actuation and response layer performs one or more functions of velocity scaling, force-limiting, trajectory deviation, emergency stop, task interruption, and haptic or audio feedback signaling.

The human-robot embodiments enable “True” Collaboration versus. Mere Coexistence. Current “cobots” coexist with humans; they don't truly collaborate. True collaboration requires understanding the partner's state. The system 1200 of FIG. 11B achieves this by fusing Human State (1210) and Robot State (1220) into a Combined Human-Robot Interaction Risk Model (1244) within the latent space. This allows the robot to make decisions based on a shared understanding of the task and the environment. For example, the robot knows not just where the human's hand is, but that the human is reaching for a specific tool and adjusts its own movements to assist or stay clear.

The embodiments also harden Safety with Zero Trust Architecture (ZTA). In a safety-critical system, users cannot just trust that the AI's output is correct. The system 1200 of FIG. 11B embeds a Policy Enforcement & Provenance Logging module (1280) directly into the safety loop. This ensures that every single modification to the safety envelope and every actuation command is: Authenticated: Based on verified sensor data; Policy-Checked: Verified against pre-defined hard safety constraints; and Logged: Recorded on an immutable ledger for post-incident analysis. These features or elements make the safety system audit-proof and highly resistant to cyberattacks or sensor spoofing, a critical requirement for military and medical applications.

In summary, the embodiments of FIG. 11B provide for multimodal fusion, latent-space reasoning, and intent prediction in a concrete, patentable architecture for solving some of the biggest practical challenges in modern robotics. Namely, providing safe and efficient human-robot collaboration. It moves the embodiments from “an AI that understands the world” to “a robot that can be trusted to work alongside people.”

Referring to FIG. 11C, in some embodiments, a block diagram depicts a resilient low-EM, subsurface, RF-denied communications layer that includes a resilient signaling module 1101 coupled to a subsurface/underground/RF-obstructed adaptation layer 1107. The layer can also include elements such a MOSA/SOSA aligned modular port 1104 coupled in parallel to a degraded-environment message router 1105 and an edge-integrated safety broadcast engine 1106. The engine 106 in turn is coupled to a ZTA layer 1102. The ZTA layer 1102 can interface with a provenance ledger interface 1103 and also provide an output to the resilient signaling module 1101. The resilient signaling module 2202 can couple to the subsurface adaptation layer 1107 before providing a resilient low-EM transmission 1109 (to a degraded environment). In some embodiments, an external platform interface 1108 provides and input the MOSA/SOSA aligned modular port 1104 as shown.

More particularly, the MOSA/SOSA aligned modular port 1104 includes a hardware abstraction layer providing a modular, open-standard interface (e.g., OpenVPX, CMOSS, SOSA-aligned payload slot) that allows the layer to be swapped, upgraded, replaced, or intgetrated into platforms without redesign. The degraded-environment message router 1105 automatically detects RF degradation, transitions to low-EM channel, prioritizes safety-critical inference messages, and maintains minimal bandwidth bidirectional status signaling. The Edge-Integrated safety broadcast engine 1106 enables broadcast of pilot impairment alerts, C-UAS threat indicators, chemical hazard detection messages, or medical emergency markers without cloud connectivity. The ZTA authentication layer 1102 can have every outbound message wrapped in policy enforcement checkpoint verifying; sensor identity, model integrity, inference authenticity, and temporal provenance before transmission. The provenance ledger interface 1103 can include a cryptographic ledger client (blockchain, DAG, etc.) that ensures each inference, sensor measurement, and safety-critical alert is recorded with immutable origin tracking. The resilient signaling module 1101 can be a low-frequency, low-probability-of-detection interface configured to operate through: magnetoelectric coupling, mechanical-acoustic hybrid signaling, or equivalent low EM transmission methods. The system would be operable where conventional RF links are unavailable. The subsurface/underground/RF-obstructed adaptation layer can have adaptive circuitry to dynamically tune transmission parameters to one or more of underwater, subterranean, reinforced structures, heavy metal occlusion zones, jamming or spoofing situations.

The layer or system of FIG. 11C provides a “guaranteed delivery mechanism” for the critical intelligence generated by the IRIS system in high-stakes, hostile environments.

While previous figures define how the system perceives (FIG. 11A), reasons (FIG. 3), and acts safely (FIG. 11B), FIG. 11C addresses a fundamental point of failure in real-world autonomous deployments: the loss of connectivity. Without this feature or aspect, the entire IRIS system could be rendered useless in certain environments the moment a robot enters a tunnel, goes underwater, or encounters enemy jamming.

The resilient communications layer solves the “Disconnected Brain” Problem in Contested Zones. In modern military (A2/AD zones) and disaster response scenarios (collapsed concrete structures), standard RF communications (GPS, Cellular, Wi-Fi, standard SATCOM) are the first things to fail, either due to physics or active jamming. The resilient communications layer of FIG. 11C provides the solution via the Resilient Signaling Module (1101) and Adaptation Layer (1107).

By providing the functional capability to switch automatically to non-traditional, low-EM modalities (like magnetoelectric or acoustic signaling) via the Degraded-Environment Message Router (1105), this figure ensures that the high-value outputs of the AI—such as the “C-UAS threat indicators” or “pilot impairment alerts” mentioned in Block 1106—can still reach human commanders or other machines when all other channels are dead. This transforms IRIS from a fair-weather system into a mission-critical asset. The resilient layer further extends the Zero Trust and Provenance to the Physical Edge. Thus, the system can provide true end-to-end Zero Trust Architecture. A critical vulnerability in competitor systems is that security protocols often stop at the software layer before transmission. The resilient communication layer closes this gap by embedding the Zero-Trust Authentication Layer (1102) and Provenance Ledger Interface (1103) directly into the communications hardware stack. This architecture means that even when transmitting over a low-bandwidth, noisy subsurface channel, every single packet is cryptographically verified. An adversary cannot spoof a “safe” signal to a submerged underwater vehicle using IRIS. This unbroken chain of custody from sensor to seabed is a significant differentiator over existing system. Additionally, the system ensures MOSA/SOSA Compliance for Rapid Acquisition.

By describing the types of signals functionally (e.g., “magnetoelectric coupling,” “low-EM transmission methods”) rather than detailing specific classified antenna designs or modulation schemes, the system or structure of FIG. 11C provides a resilient, secure, multimodal communication system that is robust even under difficult or degraded environments. It provides the robust, secure, and compliant “vocal cords” for the AI brain described in the rest of the application, making the complete system viable for the most demanding defense and industrial applications.

Referring to FIG. 11D, illustrates an autonomous state machine architecture governing how the system transitions between communication channels in response to real-time assessments of environmental conditions, trust-policy status, and sensor-verified degradation indicators.

If FIG. 11C is the “resilient voice box” of the system, FIG. 11D is the autonomic nervous system that controls it. It defines the exact deterministic logic governing when and how the system switches to survival modes. The architecture of FIG. 11D illustrates a specific, deterministic machine process or a precise algorithmic framework: If trigger T1 occurs at 1101A, then transition to state 1101B; if T2 persists at 1101B, then transition to 1101C. If a valid fallback mode is selected at 1101C, then T3 triggers a further transition to 1101D where the fallback mode is authenticated. If the authentication is completed at 1101D, a trigger T4 transitions the state to 1101E where a primary link is restored or there is an operator override. If reauthentication occurs at 1101E, T5 triggers yet another transition back to 1101C indicative of a successful reauthentication at 1101E. If reauthentication fails or a new threat occurs at 1101C, then T6 triggers a return to state 1101A.

By defining distinct states, specific triggers (like SNR collapse or jamming signatures), and mandatory actions within each state, FIG. 11D presents a technically concrete embodiment that is not at all abstract, but providing a technical solution to a technical problem. The system also incorporates or operationalizes the Zero Trust Architecture (ZTA) under duress since the system clearly demonstrates how ZTA survives when the network is under attack and demonstrates that security is not abandoned during an emergency. In the Secure Channel Selection State (1101C), the diagram specifies that “Only ZTA-verified traffic is eligible.” In the Link Recovery State (1101E), it mandates a “mutual re-authentication handshake” and verifies “no man-in-the-middle” before trusting the primary link again. The state machine of 11D further proves that the resilience is secure by design, a critical differentiator for military and critical infrastructure applications where an adversary might jam a signal just to spoof the recovery process.

The state machine also provides “True Autonomy” in Communications. Most current systems require a human operator to manually switch communication channels when a link fails. In a hypersonic environment or a collapsed mine, there is no time for human intervention. FIG. 11D defines the logic for autonomous self-healing connectivity. By automating the entire chain from detecting degradation (1101B) to selecting the physics-compliant fallback (1101C) and prioritizing safety data (1101D), the specific automated workflow demonstrates the steps to keep an unmanned system viable in denied areas without human hand-holding or intervention in most or all cases.

This specific flow, particularly the sequence of Degradation Detection->Secure Selection->Prioritized Resilient Signaling->Validated Recovery in FIG. 11D creates a broad sophisticated system that can be utilized in the defense and autonomous robotics sectors (e.g., Anduril, Skydio, defense primes, and advanced auto manufacturers).

The state machine of FIG. 11D provides the algorithmic glue that makes the resilient hardware of FIG. 11C functional and intelligent and concretely defines how an autonomous system maintains a secure lifeline in the worst possible environmental conditions.

The remainder of the description will generally refer back to FIG. 1 and in certain instances other figures as noted.

Edge-Optimized Deployment Architecture (180). As illustrated in FIG. 1, the present embodiments may be deployed in edge-compute environments subject to strict power, thermal, size, timing, or connectivity constraints. Unlike conventional AI systems that rely on high-bandwidth cloud connectivity, GPU clusters, or large-scale training infrastructure, the embodiments herein perform real-time multimodal fusion, latent-space prediction, causal inference, counterfactual simulation, and zero-trust safety enforcement entirely on-device. This architecture is expressly designed for a number of contexts including, but not limited to: vehicular platforms, medical and surgical robotics, industrial automation, defense-grade mobile systems, subsurface/underwater systems, aerospace systems, wearables and physiological-monitoring devices, and distributed IoT/operational-tech networks.

Low-Power and Thermal Constraints. In various embodiments, the system supports operation under: sub-50 watt power budgets; thermally constrained enclosures; mobile robotic or wearable systems; battery-operated platforms; sealed or harsh-environment housings. The architecture leverages: quantized models (INT8, INT4, or mixed precision); efficient temporal transformers; sparse attention mechanisms; weight sharing; low-precision accelerators; reduction of redundant sensor channels; energy-adaptive inference schedules. These features enable computationally intensive predictive intelligence to run within limited hardware envelopes.

Embedded Compute Hardware. The system may execute on: embedded CPUs (ARM, RISC-V); embedded GPUs; NPUs, VPUs, or tensor accelerators; FPGA-based inference engines; ASICs designed for multimodal fusion; and/or compact heterogeneous compute clusters. Scheduling frameworks may distribute workload across multiple accelerators in a: load-balanced, latency-bounded, power-aware, ZTA-authenticated manner.

Memory, Bandwidth, and Storage Optimization. To achieve real-time performance, the system employs: latency-optimized memory pathways; shared-memory tensor pipelines; dynamic quantization; fused operator kernels; on-chip caching of latent states; compressed provenance logs; prioritized storage of safety-critical data; local ring-buffer replay storage for continual learning. These optimizations minimize: DRAM accesses, compute overhead, thermal draw, sensor I/O bottlenecks, and inference time.

On-Device Latent-Space Prediction and Causal Inference. The embodiments perform latent-space: prediction, hazard forecasting, causal attribution, and counterfactual simulation on edge hardware, without reliance on cloud inference. This on-device execution: reduces latency; improves reliability; eliminates dependency on external networks; ensures safety in DDIL environments; enhances privacy and regulatory compliance; prevents cloud-based attack surfaces. All predictive operations are ZTA-verified and executed within the TEE.

Fallback Autonomy and DDIL Operation. In denied, degraded, intermittent, or limited communication (DDIL) environments, the system maintains autonomy using: local prediction and causal reasoning; ZTA-authenticated on-device inference; fallback rule-based controllers; minimal-sensor fusion modes; ME-based authenticated signaling; safety-supervisor override logic. Fallback pathways enable: controlled degradation, minimal-risk actuation, local-only safety enforcement, preservation of provenance logs, deferred cloud synchronization.

Secure Local Model Updates and Continual Learning. In certain embodiments, the system supports secure, on-device continual learning where gradients; distilled teacher signals; reinforcement-learning updates; encoder fine-tuning; latent-dynamics updatesare performed inside the TEE. All updates are: cryptographically authenticated; authorized by the PEP; provenance-logged; reversible through rollback mechanisms. This enables adaptation in dynamic environments without undermining system safety or violating regulatory constraints.

Real-Time Safety-Critical Timing Guarantees. To support surgical robotics, industrial equipment, vehicles, submarines, and aerospace systems, the architecture includes: deterministic worst-case execution-time (WCET) bounds; deadline-aware inference scheduling; emergency interrupt pathways; latency-bounded multimodal synchronization; actuator-command priority queues; watchdog monitors. This ensures safety across: high-speed robotic manipulation; high-velocity vehicle motion; time-sensitive medical intervention; dynamic industrial environments; underwater and subterranean signaling.

Regulatory and Domain-Specific Compliance. The edge architecture adheres to domain constraints such as: FDA, ISO, IEC for medical robotics and biosensing; automotive safety standards; industrial safety regulations; defense and aerospace interface guidelines; energy-sector operational constraints; maritime/subsurface operational requirements. This broad compliance is enabled by: on-device provenance; ZTA-bound autonomous decisions; predictable timing; deterministic, interpretable behavior; and/or multimodal hazard prevention.

Unexpected Technical Benefits. The edge-optimized architecture provides non-obvious and unexpected advantages such as: predictive intelligence that outperforms cloud-reliant architectures; real-time performance across dozens of multimodal channels; reduced attack surface due to local execution; resilience in RF-denied or GPS-degraded conditions; safe operation independent of remote compute resources; regulatory-grade interpretability via on-device causal models; domain-universal applicability.

Magnetoelectric Field-Based Communication Subsystem. In certain embodiments of the embodiments (see FIGS. 11C and 11D) include an optional resilient magnetoelectric field-based communication subsystem configured to provide authenticated, low-bandwidth signaling in environments where conventional radio-frequency (RF), optical, acoustic, or satellite communication pathways are unavailable, degraded, or unreliable. The subsystem integrates fully with the Zero Trust Architecture (ZTA) 150 and the Safety Supervisor 170 to ensure secure, provenance-verified transmission of safety-critical messages, latent-state summaries, hazard alerts, sensor-trust metadata, and system-health indicators. Unlike prior-art fallback communication systems, the disclosed subsystem is designed to operate within the constraints of subterranean, underwater, RF-denied, GPS-degraded, or electromagnetically contested environments, providing continuity of safety-critical operations without cloud or network dependency.

Magnetoelectric Signaling Principles. In various embodiments, the subsystem employs magnetoelectric (ME) field generation and sensing to transmit information. ME signaling may rely on: low-frequency electromagnetic fields; magnetoelectric coupling materials; near-field magnetic/quasistatic field propagation; modulated magnetic induction; hybrid magneto-acoustic pathways; resonant ME oscillators; ME antennas with high permeability at low frequencies. These modalities enable short-to medium-range communication in environments where: RF attenuation is severe; saltwater or dense soil prevents RF propagation; metal infrastructure creates waveguide disturbances; GPS or satellite links are blocked; and/or jamming or electromagnetic interference is present.

Subsystem Architecture. As shown in FIG. 11C, the ME-based communication subsystem 1101 may include: a ME Transmission Module that can include ME driver circuits, frequency modulation or amplitude modulation components, low-frequency waveform generators, and adaptive power-controlled drivers; a ME Receiver Module that can include magnetoelectric sensors, high-sensitivity ME detection materials, signal demodulators, noise-suppression circuits; a ZTA-Authenticated Communication Stack that can include cryptographic key exchange, message signing and verification, challenge-response authentication, anti-replay protection, and provenance tagging; an Interfacing Layer that can include MOSA/SOSA-aligned data streams, standardized transport formats, fallback safety-message channels, bandwidth-adapted serialization; and a Power-Adaptive Control Layer that can include low-power ME signaling profiles, sleep/wake cycling, energy scheduling based on predicted autonomy needs, and DDIL-optimized duty cycles.

Safety-Critical Messaging in DDIL Environments. In certain embodiments, the subsystem supports transmission of: hazard alerts; Safety Supervisor overrides; causal hazard summaries; uncertainty and trust-level metadata; actuator-inhibition commands; human-state physiological flags; gait-derived fall-risk alerts; environmental hazard indicators (chemical, thermal, structural); provenance-anchored status updates. Messages may be transmitted even when: RF jamming is active; acoustic channels are noisy; fiberoptic links are severed; satellites are unavailable; conventional radios are prohibited or compromised; underwater/subterranean conditions prevent RF usage.

Integration With Zero Trust Architecture (ZTA). All ME-based communication packets must pass through the ZTA layer, which provides: cryptographic authentication; message-origin verification; signing of ME waveform payloads; secure buffer management in the TEE; provenance logging; rejection of tampered or unverified signals. The communication subsystem never bypasses ZTA rules.

Variable-Bandwidth Encodings for Safety-Critical Content. Due to the inherently lower bandwidth of ME communications, the system employs optimized encoding approaches, such as: latent-state compression; safety-delta encoding; quantized hazard vectors; compressed causal graphs; atomic safety-rule identifiers; tokenized safety envelopes. These encodings ensure that only the most safety-critical information is transmitted.

Domain-Specific Embodiments. The ME subsystem may be used in: Vehicular and Autonomous Systems including tunnels, subways, mines; GPS-denied or electromagnetically noisy zones; or vehicle-to-vehicle fallback signaling; Industrial and Infrastructure Environments such as steel mill interiors; chemical processing facilities; underground energy networks; Medical and Surgical Settings such as shielded operating rooms; scenarios where RF communication is restricted; Underwater and Subsurface Platforms such as unmanned underwater vehicles (UUVs); underwater construction robotics; oil/gas pipeline inspection systems; subterranean or cave systems; Defense and Public-Safety Environments such as jamming-rich theaters; nuclear or electromagnetic disturbance zones; contested communications environments. The subsystem provides non-obvious technical benefits including: maintains safe operation in RF-degraded domains; interoperates with MOSA/SOSA systems; reduces reliance on external communications; offers tamper-evident low-bandwidth signaling; enhances autonomy resilience across extreme environments; complements latent-space predictive safety modules; expands the operational envelope of the overall embodiments. Exemplary Embodiments Across Domains. The following embodiments are provided by way of example only and are not intended to limit the scope of the invention. Any described features may be combined, substituted, or omitted in accordance with the claims. Vehicular and Transportation Embodiment. In some embodiments, the embodiments may be integrated into: passenger vehicles; commercial trucks; buses and mass-transit systems; autonomous shuttles; rail systems; aviation platforms including UAVs, drones, or aircraft. Predictive Hazard Detection. The system may detect: collision trajectories; pedestrian behaviors and intent; road-surface hazards; chemical leak indicators (e.g., VOCs); thermal anomalies; mechanical stress precursors; tire-slip or traction loss; driver impairment, fatigue, or physiological instability. Causal & Counterfactual Interventions. Counterfactual analysis may evaluate alternate: steering vectors; throttle/brake profiles; lane-change or avoidance trajectories; operator interactions. ZTA-Enforced Control Output. All commands-autonomous or human must be authorized: through the TEE, under Safety Supervisor review, with provenance-verified causal predictions. DDIL Vehicular Operation. Under GPS/RF-degraded conditions, the system: continues safe operation; transmits safety-delta messages using the magnetoelectric communication subsystem; reverts to fallback trajectories when necessary.

Surgical and Medical Robotics Embodiments. Some embodiments may be deployed within: robotic surgical assistants; teleoperated surgical systems; autonomous biopsy or sampling systems; medical diagnostic devices; patient-monitoring systems. For Multimodal Tissue-State Sensing, sensors may include: visual imaging (RGB, IR, NIR); thermal mapping; acoustic tissue signatures; force/pressure sensing; chemical sensing (pH, metabolites, VOCs); microfluidic biosensors. For Tissue Prediction and Risk Forecasting, Latent-space models may predict: bleeding risk; tissue deformation; thermal damage; instrument-tissue interaction hazards; infection indicators; physiological deterioration.

Surgical Safety Supervisor. The Safety Supervisor may: adjust tool trajectories; prevent unsafe instrument movement; order retraction or pause; shift to a lower-risk intervention mode; prevent motion under untrusted sensors or unexpected instrument forces. With respect to Regulatory Compliance, the System behavior may support: FDA deterministic behavior expectations; auditable safety logs via provenance ledger; surgeon override with ZTA verification.

Industrial Automation and Manufacturing Embodiments. Various embodiments may be used in: robotic assembly; automated manufacturing cells; warehouse robotics; welding, drilling, milling; heavy industrial environments; quality-control systems. With respect to Predictive Defect and Failure Detection, the system may detect: microcracks; structural fatigue; weld inconsistencies; thermal stress; acoustic-vibration anomalies; chemical precursors to material degradation. With respect to Human-Robot Interaction Safety, multimodal sensing reveals: human proximity; gesture intent; behavioral instability; gait asymmetry (e.g., predicting slips and falls); operator impairment or fatigue. With respect to Control Arbitration in Industrial Settings, unsafe robotic commands may be: adjusted; replaced; delayed; overridden; inhibited entirely. With respect to modular Interoperability, factories can: add or remove sensors; upgrade encoders; update predictive or causal models; integrate new hardware via MOSA/SOSA bus connections.

Defense, Aerospace, and Public-Safety Embodiments. Certain embodiments may be deployed within: unmanned ground vehicles; unmanned underwater vehicles; aircraft sensor pods; perimeter-surveillance systems; mobile command systems; forward-operating DDIL theaters. No embodiment automates or enables lethal force or kinetic weapons targeting. The architecture remains strictly non-weaponized and safety-oriented. DDIL Multimodal Autonomy. The system continues operating when: GPS is degraded; RF is jammed; communication channels are intermittent; sensory inputs are partially corrupted. Secure Multi-Domain Sensing. Sensors may include: thermal; infrared; vibration; chemical detection; magnetic anomaly detection; physiological and gait analysis for personnel. ME-Based Fallback Signaling. ME signaling provides: low-bandwidth authenticated status; safe-mode directives; provenance-validated alerts; hazard summaries. Mission-Safety Enforcement. The Safety Supervisor: rejects unauthorized commands; enforces region-specific policies; ensures no kinetic targeting is performed; prevents unsafe mobility patterns.

Subsurface, Underwater, and RF-Denied Embodiments. Certain embodiments may be deployed within: underwater robotics; submarine compartments; cave-mapping robots; deep-mining machinery; subterranean inspection systems; pipe-conduit inspection robots. Environmental Sensing. Sensors may detect: dissolved gases; hydroacoustic signatures; structural resonance; magnetic anomalies; thermal gradients; VOCs indicating hazards. Predictive Hazard Modeling. The system predicts: structural collapse risk; water ingress patterns; chemical plume propagation; equipment failure trajectories. ME Communication Fallback. The magnetoelectric subsystem enables: authenticated low-frequency transmissions; fallback messaging during RF blackout; coordination across distributed agents.

Human Impairment, Physiological, and Gait-Analysis Embodiments. Various embodiments may assess: respiratory distress; thermal breathing patterns; micro-expressions; behavioral stability; gait dynamics (stride, cadence, asymmetry, COM shifts); chemical markers of impairment; fatigue and cognitive load. Predictive Human-State Modeling. Latent-space and causal models infer: fall risk; impairment trajectories; task-readiness; physiological instability. Safety Intervention. The system may: alter machinery behavior; reduce robotic speed; trigger alerts; request human confirmation; enter safe-mode; disable unsafe actuation.

Medical Diagnostics and Early Warning Embodiments. Multimodal sensing enables detection of: early signs of infection via VOC patterns; cardiopulmonary instability; thermal anomalies; behavioral drift; environmental exposure risks. Counterfactual reasoning supports: “what-if” predictions of disease progression; triage decisions; optimal intervention selection.

Consumer, Wearable, and Personal-Safety Embodiments. The system may be deployed in: smart wearables; safety helmets; industrial PPE; home robotics; mobile phones; personal health devices. Lightweight Multimodal Sensing. Wearables may capture: respiration patterns; gait variability; thermal physiology; micro-expressions; VOC signatures of health or environmental hazards. On-Device Prediction. Real-time, edge-based models forecast: falls; impairment; fainting risk; heat exhaustion; hazardous-environment exposure.

Multi-Agent and Distributed-Sensing Embodiments. In some embodiments, multiple autonomous agents coordinate using: shared latent-state updates; distributed hazard consensus; ME-based fallback communication; multimodal cross-verification; group-based causal reasoning. Applications include: swarms; multi-robot teams; distributed industrial monitoring networks; disaster-response teams.

The embodiments can provide numerous technical advantages over conventional systems. These advantages arise from the integrated combination of multimodal sensing, latent-space predictive intelligence, causal inference, counterfactual simulation, zero-trust security enforcement, edge-optimized autonomy, and resilient magnetoelectric field-based communication subsystems. No prior art teaches, suggests, or renders obvious the specific architectures, interactions, or safety-critical behaviors disclosed herein. The following advantages are non-exhaustive and are presented to support novelty, non-obviousness, and technical improvement under 35 U.S. C. §§ 101, 102, 103, and 112.

Predictive Intelligence at the Latent-Space Level (Not Seen in Prior Art). Prior-art systems generally rely on: shallow feature engineering, single-modality inference, pixel-level or signal-level pattern recognition, or reactive, threshold-based triggers. In contrast, the present embodiments perform multimodal latent-space prediction, enabling: earlier hazard detection; more robust inference under degraded sensing; improved cross-modal consistency checks; and/or the ability to generalize across domains without retraining. No prior art combines heterogeneous sensory modalities into a joint latent representation with time-indexed prediction and hazard forecasting. Integrated Causal Learning and Counterfactual Reasoning. Conventional AI systems are correlational, lacking causal understanding of: mechanical events, physiological changes, environmental hazards, or human behavioral patterns. The disclosed system uniquely incorporates: causal-graph discovery; latent-variable causal attribution; intervention modeling; counterfactual simulation; risk-aware action selection. This yields demonstrably improved technical performance in safety-critical settings, particularly in preventing hazards before they materialize, a capability unknown in prior art. Zero Trust Architecture for Every Stage of the Autonomy Pipeline. Existing systems often rely on: implicitly trusted sensors, unverified model weights, unsecured communication between modules, or partial/optional integrity checks. In contrast, the present embodiments applie Zero Trust Architecture (ZTA) to: sensor input ingestion; latent transformation; predictive inference; causal reasoning; safety arbitration; actuator command issuance; communication pathways. To date, no known system integrates ZTA into a full multimodal AI pipeline with hardware-rooted attestation, provenance logging, and trusted-execution-environment isolation. Safety Supervisor with Causal-Predictive Arbitration. Prior systems use static heuristics such as: “if-else” rules, pre-defined thresholds, reactive emergency stops, simple PID or state-machine logic. The Safety Supervisor, in some embodiments, evaluates dynamic safety envelopes, interprets uncertainty matrices, arbitrates across human-issued and autonomous commands, prevents actions predicted to generate hazards, and/or applies causal predictions to override unsafe behaviors. This is non-obvious over any prior art system relying solely on reactive or rule-based safety controls.

Edge-Optimized Real-Time Execution Under Power, Thermal, and Latency Constraints. Existing multimodal AI systems typically require: cloud compute, large GPU clusters, continuous data connectivity. The disclosed architecture performs: multimodal sensing, latent inference, causal reasoning, ZTA enforcement, arbitration, and safe actuation entirely at the edge, under: low power (sub-50 W), strict thermal limits, real-time constraints, DDIL (denied/degraded/intermittent/limited) communication. This yields unexpected technical benefits in continuity, privacy, autonomy, and safety. Furthermore, the embodiments can provide Integration With MOSA/SOSA for Multi-Domain Interoperability. Existing systems are monolithic, domain-specific, or proprietary. One or more embodiments herein: supports modular hardware upgrades, accepts new sensors with minimal retraining, provides software abstraction layers, adheres to open architecture standards. This makes the system uniquely suited for: defense, industrial robotics, medical devices, transportation, underwater/subterranean systems. This cross-domain extensibility is not taught or suggested by prior art.

Resilient Magnetoelectric Field-Based Communication (Fallback Channel). Conventional fallback communication systems rely on: RF only, acoustic signaling, optical relays, or pre-existing infrastructure. The disclosed magnetoelectric subsystem: operates in RF-denied or GPS-degraded environments; supports authenticated low-bandwidth safety messages; interoperates with ZTA; is optimized for underwater, subterranean, and contested environments; ensures continuity of safety-critical operations. No prior art integrates ME-based communication into a cross-domain predictive-autonomy system.

Secure Continual Learning Within the TEE. Where prior systems: update models with no provable integrity, accept cloud-downloaded patches, expose training pathways to adversarial interference, the present embodiments provide: on-device, TEE-based continual learning; cryptographic verification of updates; provenance logging of gradient paths; rollback protection; safe integration with the Safety Supervisor. This eliminates numerous attack vectors while still allowing adaptation.

Human-State, Physiological, Behavioral, and Gait-Informed Safety. Prior systems generally focus on: driver monitoring via camera, single-modality fatigue detectors, isolated posture or gesture recognition. The disclosed embodiments can incorporate unified multimodal cues including: respiration thermal signatures, facial micro-expression dynamics, micro-movement patterns, chemical and VOC markers, stride/cadence/COM gait signatures, physiological instability prediction. This multimodal latent-space model enables early detection of: impairment, fatigue, destabilization, medical emergencies, fall risk, cognitive overload. No prior art provides this integrated level of multimodal human-state modeling in a predictive safety architecture.

Modality-Agnostic Interchangeability and Scalability. Because all modalities flow through: standardized encoders, latent embeddings, cross-modal validators, causal inference engines, the system allows: dynamic sensor addition, interchangeability without architectural redesign, scalable deployment from micro wearables to industrial systems. This adaptability has no known equivalent in prior multimodal systems.

Demonstrable Technical Improvements Over Baseline Systems. The disclosed system yields measurable improvements in: hazard prediction latency, false-positive and false-negative rates, resilience to spoofing, sensor dropout robustness, explainability and interpretability, adherence to regulatory requirements, long-term reliability under hostile conditions. These constitute concrete, technical advancements under § 101 and § 103.

Additional Definitions. The following terms are provided for clarity and are not intended to limit the scope of the claims unless explicitly recited therein. The definitions reflect exemplary meanings as used herein; alternative, equivalent, or functionally similar interpretations may also fall within the scope of the invention. “Sensor”. The term sensor refers to any device, system, material, module, or mechanism capable of detecting, measuring, inferring, estimating, or providing information about an environmental, mechanical, biological, chemical, physiological, or computational state. This includes, but is not limited to: cameras (RGB, IR, NIR, depth, event cameras); microphones, acoustic transducers, ultrasonic sensors; tactile arrays, pressure or force sensors; thermal sensors or thermographic imagers; chemical, biosensing, gas, or VOC detectors; physiological sensors (heart rate, respiration, EMG, gait, etc.); magnetometers, magnetoelectric sensors, IMUs; LIDAR, radar, mm Wave, sonar; environmental sensors (humidity, CO₂, particulate, etc.). Sensors may be physical or virtual and may include derived, inferred, or preprocessed data from any of the above.

“Multimodal”. The term multimodal refers to the use of two or more sensing modalities, data types, signal sources, or informational channels, including combinations of: visual, acoustic, tactile, olfactory, gustatory; thermal, chemical, physiological, biomechanical; radar, sonar, magnetoelectric, RF, optical; derived or algorithmic modalities such as pose, gait, or intent. Multimodal includes simultaneous, sequential, asynchronous, or partially overlapping data streams.

“Latent Space” or “Latent-State Representation” Latent space refers to any compressed, encoded, abstracted, or transformed representation of multimodal data produced by one or more encoders, neural networks, causal models, or transformation modules. Latent states may be continuous or discrete, probabilistic or deterministic, and may encode: dynamics, spatial or temporal structure, causal relationships, physiological markers, mechanical properties, intent or behavioral cues. No specific dimensionality is required.

“Prediction,” “Predictive Model,” or “Predictive Inference”. These Terms Refer to computational processes that estimate present, future, or hypothetical system states, including but not limited to: hazard forecasting; trajectory prediction; material-state estimation; human physiologic or behavioral prediction; counterfactual outcome estimation; time-series extrapolation; model-based simulation. Prediction may involve statistical, neural, causal, rule-based, or hybrid methods.

“Causal Inference,” “Causal Model,” or “Causal Graph”. These terms refer to any method that infers, encodes, or evaluates causal relationships, including: structural causal models (SCMs); DAG-based causal graphs; latent-variable causal relationships; interventional vs. observational distinctions; counterfactual reasoning; causal attribution or feature importance. Causality may be learned, predefined, hybrid, or adaptively updated.

“Zero Trust Architecture” (ZTA). Zero Trust Architecture refers to any security model that assumes no implicit trust between system components and requires continuous, authenticated validation of: sensor data integrity; model weights and parameters; firmware or software authenticity; communication pathways; user or module authorization; provenance of computational steps. ZTA may include TEEs, cryptographic modules, secure enclaves, policy enforcement engines, access controls, and provenance loggers.

“Trusted Execution Environment” (TEE). A Trusted Execution Environment is any hardware- or software-based secure environment that ensures: isolated execution; cryptographic integrity; controlled entry/exit points; tamper-resistant execution of sensitive computations; secure storage of keys and authentication materials. TEE includes ARM TrustZone, Intel SGX, AMD SEV, RISC-V secure enclaves, FPGA-based secure partitions, or equivalents.

“Sensor Fusion”. Sensor fusion refers to any process that combines two or more sensory inputs into a unified representation. This may include: early, mid, or late fusion; temporal synchronization; cross-modal consistency testing; physics-based matching; latent-space fusion; probabilistic or deterministic integration.

“Actuator” or “Actuation Command”. Actuator refers to any mechanism capable of physical movement, force application, control, or mechanical output. Examples include: vehicle control surfaces; robotic joints, grippers, or end effectors; surgical instruments; industrial machines; UAV propulsion systems; wearable exoskeleton actuators. Actuation commands may modify position, velocity, torque, pressure, or any other physical parameter.

“DDIL Environment”. A DDIL environment refers to Denied, Degraded, Intermittent, or Limited communication conditions. DDIL may include: RF jamming; underwater/subsurface conditions; damaged or destroyed infrastructure; electromagnetic disturbance zones; GPS-degraded areas.

“Magnetoelectric Field-Based Communication Subsystem”. This term refers to any communication mechanism utilizing: magnetoelectric coupling; low-frequency electromagnetic or quasistatic fields; magnetic induction-based signaling; ME antennas, sensors, or materials; hybrid magneto-acoustic or magneto-capacitive propagation. It includes both transmission and reception components and is not limited to any specific hardware implementation.

“safety Supervisor,” “safety Arbitration,” or “safety Envelope”. These Terms encompass any logic, module, or system that: evaluates predicted hazards; enforces safe operating limits; prevents unsafe commands; overrides or modifies autonomous or human-issued commands; triggers fallback modes; imposes deterministic safety bounds. Safety envelopes may be geometric, temporal, physiological, mechanical, or causal.

“Counterfactual Reasoning”. This term refers to computation of: hypothetical outcomes (“what-if scenarios”); altered intervention trajectories; modified system states; alternative control inputs; risk-weighted comparisons under alternative assumptions.

“Model Update,” “Continual Learning,” or “Adaptive Learning”. These terms refer to any process by which: model parameters, latent dynamics, encoder mappings, predictive components, or causal-graph structures are modified, whether online or offline. Updates may occur within the TEE or via secure attestation.

“Human-State Indicators”. This includes: pose, gesture, micro-movements; thermal respiratory signatures; behavioral cues; gait parameters; chemical markers; physiological signals (heart rate, saturation, respiration, tremor, etc.); cognitive load, impairment indicators, or fatigue markers.

The embodiments, examples, algorithms, architectures, modules, subsystems, communication mechanisms, sensors, materials, encoders, causal models, predictive techniques, safety mechanisms, and operational workflows described herein are provided solely for purposes of illustration and explanation. Nothing in the foregoing specification is intended to, nor should be construed to, limit the scope of the claims or to the specific embodiments disclosed. Unless explicitly stated otherwise, any feature, step, component, function, characteristic, or configuration described herein may be combined with, substituted for, omitted from, or implemented in alternative form in any other embodiment without departing from the spirit or scope of the embodiments.

It will be apparent to persons skilled in the art that numerous modifications, equivalents, variations, substitutions, and alternative implementations may be made in light of the teachings herein. These modifications and equivalents are deemed to fall within the scope of the present disclosure and are intended to be encompassed by the claims.

No embodiment, example, figure, drawing, or description herein shall be interpreted as limiting the invention to a particular domain, application, modality, sensor type, communication technology, computational architecture, or safety-critical environment. The embodiments are expressly intended to be domain-agnostic, modality-agnostic, architecture-agnostic, and implementation-agnostic unless specified otherwise by the claims. Furthermore, no feature or element described herein should be construed as essential to the embodiments unless explicitly recited as such in the claims. Any reference to prior art is provided solely for context and does not constitute an admission that the referenced material forms part of the common general knowledge in any jurisdiction.

Public Benefit, Non-Weaponization, and Ethical Use Statement. The systems, methods, and architectures described herein are designed and intended solely for public benefit, human safety, environmental protection, and non-lethal applications. The embodiments advance the state of the art in safety-critical sensing, predictive hazard prevention, autonomous system verification, multi-domain resilience, and trustworthy real-time decision-making. Nothing in this disclosure is directed to, nor should be construed as enabling, facilitating, or optimizing: kinetic targeting; weapons guidance; weapons activation; lethal autonomous weapons; offensive military engagement; destructive cyber operations; or any system intended to harm human beings.

All architectures, predictive models, causal-inference engines, safety-enforcement mechanisms, communications subsystems, and multimodal sensing frameworks are configured to operate within strict safety envelopes, Zero Trust policy constraints, and non-weaponized operational contexts. In certain embodiments, the embodiments may be deployed within industrial, medical, vehicular, transportation, environmental, subterranean, underwater, aerospace, or defense-support environments; however, its functionality is expressly limited to hazard detection, safety monitoring, risk mitigation, navigation assurance, life preservation, physiological and environmental sensing, equipment protection, and non-lethal decision support. Any deployment within defense or government contexts remains restricted to: rescue and recovery operations; situational awareness; infrastructure safety and inspection; communications resilience; emergency response; accident prevention; non-lethal mission assurance. The embodiments are architected to support ethical AI principles, including: human-in-the-loop or human-on-the-loop supervision; transparent and auditable decision-making via provenance logs; privacy-preserving, edge-based processing when feasible; prevention of tampering or unsafe autonomous behavior; bias-mitigation safeguards within model-update pathways; adherence to applicable international safety and export regulations.

No embodiment is intended to replace human judgment in contexts involving lethal decision-making, nor does the invention perform or enable autonomous lethal action. Any causal reasoning, counterfactual simulation, or predictive inference described herein is exclusively directed toward non-harmful, safety-enhancing outcomes.

The Applicant expressly disclaims any interpretation of this disclosure that would place the embodiments within the scope of autonomous weapons, offensive targeting systems, or any technology whose primary function is to inflict harm. The embodiments are intended to further global safety, reduce accidents, prevent impairment-related harm, enhance resilience in critical environments, and promote responsible, ethical use of artificial intelligence and sensing technologies.

The disclosed system in some embodiments may include a resilient communication subsystem designed to ensure continuity of mission-critical operation during degraded or absent network conditions. Such subsystem may employ cellular text or control-channel messaging, low-frequency radio, peer-to-peer mesh networking, optical signaling, acoustic transmission, or magnetoelectric field-based communication. This ensures data exchange between agents or between agents and supervisory control systems, even where traditional internet, satellite, or cloud infrastructures are unavailable. Magnetoelectric signaling may further enable subterranean, underwater, or shielded-domain communication where electromagnetic propagation is limited. Diagnostic or safety data recorded during such offline operation are later reconciled through blockchain verification upon restoration of full connectivity, preserving data integrity and chain-of-custody compliance.

Certain aspects of the embodiments involve edge autonomy and energy sustainability. In various embodiments, the inference and decision-making processes can occur at the edge, within the autonomous agent itself, reducing latency, conserving energy, and minimizing dependency on cloud compute infrastructure. This ensures continuous operation in power-constrained or connectivity-limited environments while preserving user privacy and regulatory compliance (HIPAA, GDPR, ISO/IEC 27001).

Certain aspects of the embodiments involve collective learning and ethical oversight. Some embodiments further contemplate secure, privacy-preserving data aggregation across distributed agents using federated learning. This approach allows collective intelligence to emerge across robotic, vehicular, and environmental networks without centralizing personally identifiable or sensitive data. The blockchain audit trail and magnetoelectric transmission options together establish an ethically aligned, resilient cognitive infrastructure suitable for deployment in healthcare, transportation, defense, and public safety.

The embodiments herein are intended to generally be in compliance with U.S. defense acquisition standards (MOSA/SOSA/ZTA) alongside the unique, high-value sensory technology of the XGenesis stack.

Some portions, or any combination of the specifics, or all of the specifics for the various technologies and standards can be incorporated in the various embodiments, including, but not limited to one or more of SOSA/MOSA; ledger/blockchain; ME/optical/acoustic/cellular/mesh; federated learning; TEE attestation; poisoning defenses; and the domain-specific platforms.

Some embodiments can include Interface agnosticism (SOSA optional) blocks that form a “proprietary backplane” and incorporate all design-arounds.

Some embodiments can have a Single-modality and NLP coverage and would otherwise cover any contemplated single modality along with natural language programming.

Some embodiments contemplate Adaptive fusion and uncertainty and supervisor blocks such that fusion is use and the embodiment cover both gated and ungated actions.

Some embodiments contemplate the use of Generic ZTA provenance (blocks where either signed logs are used or blockchain is used.

Some embodiments contemplate Edge and federated learning where cloud-first architected systems would need to implement the claimed embodiments.

With respect to TEE attestation, it means that every time the embodiments of the IRIS “brain” herein runs an AI model or fuses sensor data, it produces a cryptographic proof. Such cryptographic proof would include:
(1). A binary file (the executable file) that hasn't been modified.
(2). Model weights (the trained parameters) that are exactly what they're supposed to be and not swapped or poisoned.
(3). A runtime environment (firmware, kernel, driver versions, etc.) that hasn't been tampered with.

The Trusted Execution Environment (TEE), such as Intel SGX, ARM TrustZone, AMD SEV, or DoD-compliant enclaves creates an isolated secure region on the chip. Inside that enclave, a hash (unique fingerprint) of the software, model, and memory state is generated. That hash is signed by a hardware root key and recorded in the provenance ledger (blockchain or cryptographically authenticated log).

Without this attestation, a competitor or adversary could try to “work around” our system by asserting that

“They use secure logs and encrypted transport, but we didn't use a blockchain and we didn't need attestation.”

Our system's security and credibility rest on verifiable trust that what's running is authentic in any form whether secure logs and encrypted transport is used or blockchain is use or any other mechanism is provided for a trusted environment.

In other words, the system could include a processing module having a Trusted Execution Environment (TEE) configured to: (a) generate a cryptographic attestation of a hash representing the executable binary, model weights, and runtime environment prior to inference; (b) sign said attestation using a hardware-anchored key; and (c) transmit the attestation to the provenance module for inclusion in a tamper-evident record.

This makes any “black-box” imitation without TEE attestation still read on the claimed embodiments, or else insecure and non-compliant with zero-trust requirements.

The embodiments also contemplate being effective against at least two different threats including Model Swap Attacks where an attacker replaces your trained weights with subtly poisoned one or with Firmware patch attacks where the attacker alters GPU/driver/kernel to exfiltrate data or fake inference. The TEE attestation includes the runtime environment hash, so falsified drivers invalidate the proof.

In some embodiments, the TEE attestation can include attestations of binary, weights, and/or runtime. In some embodiments, the system generates a hardware-anchored attestation report including hashes of the model executable, parameter weights, and runtime environment, signed within a Trusted Execution Environment (TEE) and logged to the provenance ledger to establish end-to-end integrity.

With respect to security, the TEE can prevent adversarial substitution, malware injection, or “secure-logging-only” clones and can further bolster Zero Trust compliance.

Trusted Execution and Provenance Architecture. In certain embodiments, the processing module of the system operates within a Trusted Execution Environment (TEE), providing hardware-enforced isolation for safety-critical inference and decision functions. The TEE establishes a secure enclave in which the multimodal fusion engine and its associated machine learning model weights are executed. Prior to performing any inference, the TEE generates a cryptographic attestation report that can include
1. a first hash corresponding to the executable binary of the inference engine;
2. a second hash corresponding to the active model weights, configuration parameters, and feature normalization vectors; and
3. a third hash corresponding to the runtime environment including firmware, kernel, and device driver versions present during execution.

The attestation report is digitally signed using a hardware-anchored private key burned into the trusted hardware root of the processor. The signed report is transmitted to the system's provenance module, where it is inserted into a tamper-evident, append-only ledger (for example, a blockchain, Merkle tree, or equivalent distributed log). The ledger may be local, federated, or global in scope and is configured to enable cryptographic proof of model lineage, software integrity, and inference authenticity.

In some embodiments, the TEE communicates directly with a Zero Trust Architecture (ZTA) enforcement layer, acting as a Policy Enforcement Point (PEP) that validates all inference requests, model updates, and data transactions prior to actuation. The ZTA layer verifies that the attestation proof is valid, current, and issued from an authorized enclave. If validation fails, inference results are quarantined and the safety supervisor halts actuation until human or supervisory verification occurs.

The provenance ledger, once updated, becomes immutable. Each new attestation entry includes a cryptographic reference (e.g., SHA-3 or PQC-based hash) to the preceding block, ensuring end-to-end traceability and non-repudiation of all AI-driven decisions. The attestation chain thereby produces an auditable record demonstrating that no unauthorized modification occurred to the model, code, or runtime between attestations.

In further embodiments, this attestation mechanism supports federated learning. Individual devices or platforms may perform edge-level training or fine-tuning within their respective TEEs. Only model weight deltas, encrypted and signed with enclave keys, are transmitted to a central aggregator. This design preserves privacy, sovereignty, and data integrity across distributed deployments while maintaining Zero Trust compliance.

In degraded environments, or when communication with supervisory nodes is interrupted, the system continues operating autonomously. Each edge node locally maintains attestation and provenance logs within its enclave until communication resumes, at which point a resilient synchronization protocol ensures ledger consistency without data duplication or conflict.

Through these combined mechanisms, the system achieves verifiable end-to-end integrity—from raw sensor capture to inference, decision, actuation, and archival, forming a cryptographically provable chain of trust that precludes tampering, spoofing, or adversarial model substitution.

Various embodiment for “TEE, Provenance, and Federated Integrity”.

In some embodiments the processing module can include a Trusted Execution Environment (TEE) configured to execute the inference engine in hardware-isolated memory and prevent unauthorized access to model parameters or intermediate feature representations.

In some embodiments, the TEE generates a cryptographic attestation report including at least one of: (a) a hash of an executable binary of the inference engine; (b) a hash of model weights, configuration files, or normalization vectors; and (c) a hash of a runtime environment including firmware and driver versions.

In some embodiments, the attestation report is digitally signed using a hardware-anchored key embedded in the trusted hardware root of the processor and transmitted to a provenance module configured to store the signed report in a tamper-evident, append-only ledger.

In some embodiments, the provenance module comprises a distributed ledger or blockchain maintaining cryptographically verifiable linkages between sequential attestation records, thereby enabling end-to-end proof of model authenticity and runtime integrity.

In some embodiments, the Zero Trust Architecture layer rejects any inference, actuation, or model update whose attestation proof fails signature or freshness validation, thereby enforcing trust-before-use at the device level.

In some embodiments, each TEE participates in a federated learning protocol that exchanges encrypted model weight deltas signed by enclave-specific keys, permitting global model improvement without exposing raw data or unverified binaries.

In some embodiments, the ledger synchronization protocol employs resilient communications selected from low-frequency RF, optical, magnetoelectric, acoustic, or peer-to-peer mesh links to maintain attestation continuity in contested or bandwidth-denied environments.

In some embodiments, attestation records include timestamps, enclave identifiers, and public verification keys such that an external auditor can independently confirm that the model binary, weights, and runtime environment have not been altered since the last verified execution.

In some embodiments, the attestation and provenance records collectively constitute a Zero Trust-compliant audit chain establishing cryptographic accountability for every inference, decision, and actuation performed by the system.

Again, the Trusted Execution and Provenance Architecture can preclude “secure logging only” workarounds because every inference requires a TEE-generated proof, not just an encrypted log. It can also prevent poisoned model swaps where adversaries can't replace weights or binaries without invalidating the attestation hash. Furthermore, such arrangement can satisfy both DoD MOSA/SOSA and NIST ZTA frameworks, aligning with current Section 224 of the FY2024 NDAA and Executive Order 14110 (“Safe, Secure, and Trustworthy AI”). Additionally, these embodiments are adaptable to both civilian and military applications from automotive to naval to aerospace and beyond.

Continual Learning Framework. In certain embodiments, the system further comprises a Continual Learning Framework executed within the Trusted Execution Environment (TEE). This framework enables secure, on-device, continual learning through a hybrid process combining reinforcement learning (RL) and teacher-guided distillation, referred to herein as on-policy distillation. The process allows the system to acquire new skills or behavioral refinements through trial-and-error reinforcement while simultaneously preserving prior competencies by applying dense evaluative feedback from a supervisory model.

Within this framework, the local model generates responses to environmental or operational stimuli and receives real-time graded feedback from a teacher model, either internal or cloud-attested, evaluating each prediction token or inference step. This method achieves high-density learning signals without catastrophic forgetting, maintaining stable performance across prior domains.

All model update events, including weight deltas, version identifiers, and performance metrics are hashed and immutably logged to the blockchain-based provenance ledger. Each update transaction is cryptographically signed and timestamped, allowing full traceability and rollback capability. Reinforcement reward data and teacher feedback are exchanged exclusively through Zero-Trust authenticated channels, ensuring that no external or adversarial agent can inject unauthorized behavioral changes.

In distributed deployments, multiple edge nodes may perform localized on-policy distillation sessions using context-specific data, then synchronize learned parameters through a federated consensus protocol. This architecture allows the invention to evolve safely and autonomously over time while maintaining compliance with data sovereignty, privacy protection, and model integrity requirements across civilian, industrial, and public-safety applications.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The applicant notes that the embodiments herein advance open-architecture safety and diagnostic capabilities applicable to civilian transportation, healthcare, and industrial safety. It is not limited to nor primarily directed toward classified or offensive military applications. Public dissemination of these methods is in the interest of U.S. technological leadership and citizen safety.

1. A safety-critical autonomous intelligence system, comprising:
a processor; and
a memory storing instructions that, when executed by the processor, cause the processor to perform operations comprising:
acquiring multimodal sensor data from a plurality of heterogeneous sensors comprising at least two of: visual sensors, acoustic sensors, tactile sensors, thermal sensors, chemical sensors, physiological sensors, inertial sensors, environmental sensors, or magnetoelectric sensors;
preprocessing the multimodal sensor data, including at least one of: noise filtering, temporal alignment, sensor-source authentication, integrity verification, modality-specific calibration, or cross-modal consistency checking;
generating a unified latent-space representation using a plurality of modality-specific encoders and a joint-embedding fusion module;
generating a predicted latent state using a latent-space predictive intelligence model configured to compute at least one of: a time-indexed predicted latent state, a multi-step trajectory forecast, a hazard-forecast metric, or an uncertainty estimate;
performing causal reasoning using a causal-learning engine configured to infer causal relationships, generate a causal graph, perform interventional simulations, perform counterfactual simulations, or evaluate alternative hypothetical actions;
determining, via a safety-supervisor module, whether an actuator command is permitted, modified, or inhibited based at least in part on: the predicted latent state, a causal-reasoning output, a safety envelope, or an uncertainty metric; and
generating a verified actuator command for controlling a mechanical, vehicular, robotic, industrial, medical, wearable, or other physical system only when the actuator command satisfies the zero-trust and safety-supervisor constraints.

2. The system of claim 1, wherein the multimodal sensor data further comprises physiological signals derived from thermal-respiratory imaging.

3. The system of claim 1, wherein the chemical sensor comprises a volatile organic compound sensor configured to detect analytes associated with impairment, health conditions, or environmental hazards.

4. The system of claim 1, wherein the inertial sensor or gait sensor is configured to capture stride length, cadence, center-of-mass motion, limb-movement asymmetry, or micro-movement instabilities.

5. The system of claim 1, wherein the joint-embedding fusion module is configured to generate uncertainty estimates associated with latent-state predictions.

6. The system of claim 1, wherein the latent-space predictive intelligence model comprises a temporal transformer or recurrent neural network configured to generate multi-step predicted latent-state trajectories.

7. The system of claim 1, wherein the causal-learning engine is further configured to compute causal-attribution scores indicating relative influence of latent variables on predicted outcomes.

8. The system of claim 1, wherein the processor is further configured to perform the operation of enforcing a zero-trust security architecture by verifying at least one of: sensor authenticity, model-parameter integrity, output provenance, or authorization of a control action and wherein enforcing the zero-trust security architecture comprises verifying model-parameter integrity using cryptographic signatures or secure-enclave attestation.

9. The system of claim 1, further comprising a provenance ledger configured to store cryptographic integrity values associated with sensor data, latent-state representations, predictive outputs, or actuator decisions.

10. The system of claim 1, wherein the processor is further configured to operate in a denied, degraded, intermittent, or limited communication (DDIL) environment.

11. The system of claim 1, wherein executing the latent-space predictive intelligence model comprises performing inference on an edge-optimized processor subject to thermal, latency, or power constraints.

12. A causal-reasoning and counterfactual-simulation system for autonomous intelligence, comprising:
a processor; and
a memory storing instructions that, when executed by the processor, cause the processor to perform operations comprising:
receiving a latent-state representation derived from multimodal sensor data;
generating a causal model comprising one or more causal relationships among latent variables;
generating a causal graph representing directional dependencies among the latent variables;
performing an interventional simulation by modifying at least one latent variable to generate an alternative hypothetical latent state;
performing counterfactual reasoning by computing one or more counterfactual outcomes corresponding to the alternative hypothetical latent state;
computing a causal impact measure representing a predicted difference between: a baseline predicted latent trajectory and the counterfactual outcome; and
providing the causal impact measure to a safety-supervisor module configured to authorize, modify, or inhibit an actuator command.

13. The system of claim 12, wherein generating the causal model comprises learning causal structure using structural causal-model techniques.

14. The system of claim 12, wherein performing interventional simulations comprises modifying one or more predicted input conditions to generate hypothetical latent trajectories.

15. The system of claim 12, wherein counterfactual reasoning comprises evaluating outcomes associated with a changed actuator command or changed environment variable.

16. A safety-supervision and control-arbitration system, comprising:
a processor; and
a memory storing instructions that, when executed by the processor, cause the processor to perform operations comprising:
receiving predictive intelligence outputs comprising at least one of: a predicted latent state, a predicted multi-step trajectory, a hazard-forecast metric, or an uncertainty estimate;
receiving causal-reasoning outputs comprising at least one of: a causal graph, a causal-attribution score, a counterfactual outcome, or an interventional simulation result;
generating a dynamic safety envelope defining permissible operational limits;
receiving a candidate actuator command from an autonomous controller, a human operator, or a distributed autonomous node; comparing the candidate actuator command to the dynamic safety envelope;
performing control arbitration to permit, modify, inhibit, or override the candidate actuator command; and
outputting a verified actuator command to a mechanical, vehicular, robotic, industrial, medical, wearable, environmental, subterranean, or underwater platform only when the verified actuator command satisfies both the dynamic safety envelope and the zero-trust constraints.

17. The system of claim 16, wherein generating the dynamic safety envelope comprises integrating hazard-forecast metrics with uncertainty estimates.

18. The system of claim 16, wherein the processor is further configured to perform the operation of enforcing one or more zero-trust verification operations on the candidate actuator command, the operations comprising at least one of: integrity verification, authorization verification, provenance verification, or tamper detection; and wherein enforcing one or more zero-trust verification operations further comprises validating actuator-command provenance and detecting unauthorized or tampered commands.

19. The system of claim 16, wherein performing control arbitration comprises initiating a safe-mode or fallback operation when the candidate actuator command exceeds a permissible risk threshold.

20. The system of claim 16, wherein the verified actuator command controls a mechanical, vehicular, robotic, industrial, medical, wearable, environmental, subterranean, or underwater platform.
